(19) United States
(12) Patent Application Publication
(10) Pub. No.: US 2025/0360409 A1
(43) Pub. Date: Nov. 27, 2025

(54) VIRTUAL SCENE-BASED IDENTIFIER PROMPTING METHOD AND APPARATUS, DEVICE, MEDIUM, AND PRODUCT

(71) Applicant: Tencent Technology (Shenzhen) Company Limited, Shenzhen (CN)

(72) Inventors: Yinglong LI, Shenzhen (CN); Zhongcong Qiu, Shenzhen (CN); Cun Xu, Shenzhen (CN); Sirong Xu, Shenzhen (CN)

(21) Appl. No.: 19/295,380

(22) Filed: Aug. 8, 2025

Related U.S. Application Data
(63) Continuation of application No. PCT/CN2024/086417, filed on Apr. 7, 2024.

(30) Foreign Application Priority Data
Jun. 2, 2023 (CN) 202310654102.4

(51) Int. Cl. A63F 13/5372; A63F 13/52; A63F 13/5375; A63F 13/5378; A63F 13/56

(52) U.S. Cl. CPC A63F 13/5372; A63F 13/52; A63F 13/5375; A63F 13/5378; A63F 13/56

(57) ABSTRACT

This application provides a virtual scene-based identifier prompting method performed by a computer device. The method includes: displaying a virtual scene including a virtual object controlled by a user of the computer device; in response to a map viewing operation by the user, displaying a virtual map representing a scene distribution including at least one first point-of-interest identifier representing a position of a first point of interest in the virtual scene; and in response to a trigger operation on the first point-of-interest identifier, displaying, on the virtual map, a second point-of-interest identifier representing a position of a second point of interest in the virtual scene and an association indication identifier indicating a correspondence between the first point of interest and the second point of interest, the second point of interest being configured for controlling a functional status of the first point of interest.

### CROSS-REFERENCE TO RELATED APPLICATIONS

This application is a continuation application of PCT Patent Application No. PCT/CN2024/086417, entitled “VIRTUAL SCENE-BASED IDENTIFIER PROMPTING METHOD AND APPARATUS, DEVICE, MEDIUM, AND PRODUCT” filed on Apr. 7, 2024, which claims priority to Chinese Patent Application No. 202310654102.4, entitled “ELEMENT DISPLAY METHOD AND APPARATUS ON VIRTUAL MAP, DEVICE, MEDIUM, AND PRODUCT” filed on Jun. 2, 2023, both of which are incorporated herein by reference in their entirety.

### FIELD OF THE TECHNOLOGY

This application relates to the technical field of virtual environments, and in particular, to a virtual scene-based identifier prompting method and apparatus, a device, a medium, and a product.

### BACKGROUND OF THE DISCLOSURE

A virtual map in a game is an important means for helping a player find a path and understand each point of interest in a level. In some complex scenes, completing a game task may involve a plurality of points of interest located in different areas. For example, an interaction needs to be performed at a point of interest 1 to complete the game task at a point of interest 2.

In the related art, point-of-interest identifiers respectively corresponding to the plurality of points of interest are usually all presented on a map. For example, a point-of-interest identifier corresponding to the point of interest 1 and a point-of-interest identifier corresponding to the point of interest 2 are simultaneously displayed.

However, the foregoing method is usually disordered because point-of-interest identifiers on the map are excessively displayed, which does not help express subordination relationships between some points of interest (for example, the point of interest 1 is premise of completing the game task at the point of interest 2, which may be considered that the point of interest 1 is premise for the point of interest 2), which does not help the player better understand different points of interest, resulting in poor readability of the virtual map.

### SUMMARY

Embodiments of this application provide a virtual scene-based identifier prompting method and apparatus, a device, a medium, and a product, which can improve readability of a virtual map. The technical solutions are as follows.

According to an aspect, a virtual scene-based identifier prompting method performed by a computer device, the method including:
displaying a virtual scene, the virtual scene comprising a virtual object controlled by a user of the computer device;
in response to a map viewing operation by the user of the computer device, displaying a virtual map representing a scene distribution of the virtual scene, the virtual map comprising at least one first point-of-interest identifier representing a position of a first point of interest in the virtual scene; and
in response to a trigger operation on the first point-of-interest identifier by the user of the computer device, displaying, on the virtual map, a second point-of-interest identifier representing a position of a second point of interest in the virtual scene and an association indication identifier indicating a correspondence between the first point of interest and the second point of interest, wherein the second point of interest is configured for controlling a functional status of the first point of interest.

According to another aspect, a computer device is provided, including a processor and a memory, the memory having at least one instruction, at least one program, a code set, or an instruction set stored therein, the at least one instruction, the at least one program, the code set, or the instruction set being loaded and executed by the processor and causing the computer device to implement the virtual scene-based identifier prompting method according to any one of the foregoing embodiments of this application.

According to another aspect, a non-transitory computer-readable storage medium is provided, having at least one instruction, at least one program, a code set, or an instruction set stored therein, the at least one instruction, the at least one program, the code set, or the instruction set being loaded and executed by a processor to implement the virtual scene-based identifier prompting method according to any one of the foregoing embodiments of this application.

According to another aspect, a computer program product or a computer program is provided, the computer program product or the computer program including a computer instruction, the computer instruction being stored in the computer-readable storage medium. The processor of the computer device reads the computer instruction from the computer-readable storage medium. The processor executes the computer instruction, causing the computer device to perform the virtual scene-based identifier prompting method according to any one of the foregoing embodiments.

The technical solutions provided in the embodiments of this application have at least the following beneficial effects.

The virtual map configured to represent the scene distribution of the virtual scene is displayed through the map viewing operation, and the second point-of-interest identifier and the association indication identifier are displayed based on the trigger operation on the first point-of-interest identifier on the virtual map. A correspondence exists between the first point of interest and the second point of interest, and the second point of interest may control the functional status of the first point of interest. The process of triggering the first point-of-interest identifier to display the second point-of-interest identifier and the association indication identifier may avoid a problem of clutter on interface display because excessive point-of-interest identifiers are displayed on the virtual map. The second point-of-interest identifier is displayed as an attached identifier behind the first point-of-interest identifier, to fully utilize the correspondence between the first point-of-interest identifier and the second point-of-interest identifier. The correspondence may further be embodied through the association indication identifier more clearly and intuitively, thereby simplifying the point-of-interest identifiers on the virtual map, and avoiding a problem of data interference caused by excessive identifiers display on the user. Readability of the virtual map is improved, and efficiency of human-computer interaction is helped improve.

### BRIEF DESCRIPTION OF THE DRAWINGS

FIG. 1 is a schematic diagram of a virtual scene-based identifier according to an exemplary embodiment of this application.

FIG. 2 is a schematic diagram of a virtual scene running system according to an exemplary embodiment of this application.

FIG. 3 is a flowchart of a virtual scene-based identifier prompting method according to an exemplary embodiment of this application.

FIG. 4 is a schematic diagram of a virtual scene according to an exemplary embodiment of this application.

FIG. 5 is a schematic diagram of a virtual map according to an exemplary embodiment of this application.

FIG. 6 is a schematic diagram of a second point-of-interest identifier and an association indication identifier according to an exemplary embodiment of this application.

FIG. 7 is a schematic diagram of a virtual map according to an exemplary embodiment of this application.

FIG. 8 is a flowchart of a second point-of-interest marking method according to an exemplary embodiment of this application.

FIG. 9 is a schematic diagram of a second point-of-interest marking control according to an exemplary embodiment of this application.

FIG. 10 is a schematic diagram of a second point-of-interest marking control according to another exemplary embodiment of this application.

FIG. 11 is a schematic diagram of a second point-of-interest marking effect according to an exemplary embodiment of this application.

FIG. 12 is a flowchart of a second point-of-interest interaction method according to an exemplary embodiment of this application.

FIG. 13 is a schematic diagram of an interaction control according to an exemplary embodiment of this application.

FIG. 14 is a flowchart of marking a second point of interest according to an exemplary embodiment of this application.

FIG. 15 is a schematic diagram showing configuration of a display element according to an exemplary embodiment of this application.

FIG. 16 is a structural block diagram of a virtual scene-based identifier prompting apparatus according to an exemplary embodiment of this application.

FIG. 17 is a structural block diagram of modules of a virtual scene-based identifier prompting apparatus according to an exemplary embodiment of this application.

FIG. 18 is a structural block diagram of a terminal according to an exemplary embodiment of this application.

### DESCRIPTION OF EMBODIMENTS

To make objectives, technical solutions, and advantages of this application clearer, implementations of this application are further described in detail below with reference to the drawings.

Although the terms such as “first” and “second” may be used in the present disclosure to describe various information, the information is not limited to these terms. These terms are merely configured for distinguishing between information of the same type. For example, without departing from a scope of the present disclosure, a first parameter may also be referred to as a second parameter, and similarly, the second parameter may also be referred to as the first parameter. Depending on the context, for example, the word “if” used herein may be interpreted as “at” or “when,” or “in response to a determination”.

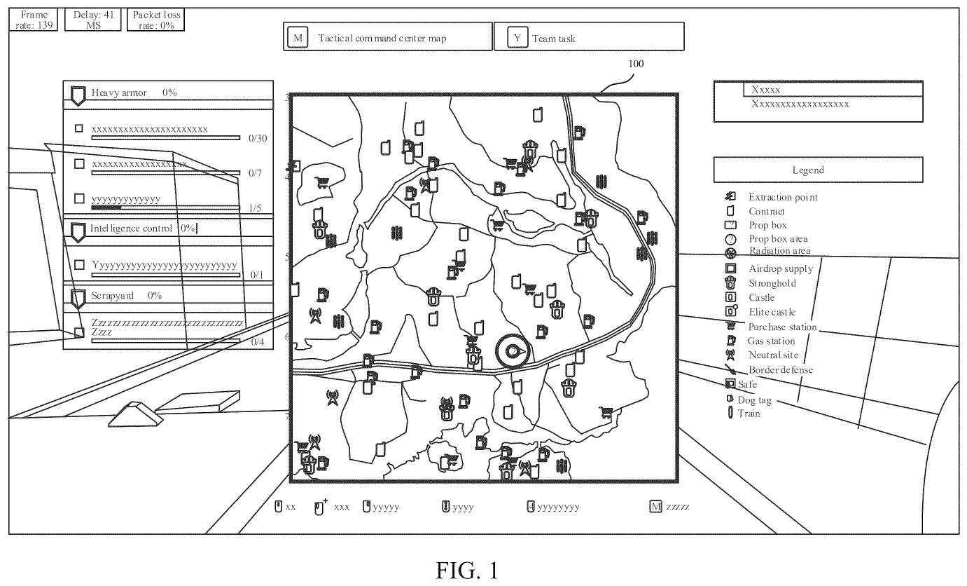

A virtual map is an important means for helping a player find a path and understand each point of interest on a level in a game. In some complex scenes, the point of interest may have many cross-area attached elements as a result of playing methods of the point of interest. In the related art, when the point of interest has many cross-area attached elements, all the elements are generally presented on a map, and a screening function is added to screen a display element. Exemplarily, FIG. 1 is a schematic diagram of a virtual scene-based identifier according to an exemplary embodiment of this application. As shown in FIG. 1, a virtual map 100 displays a scene distribution of a player in the virtual scene, and simultaneously displays all point-of-interest identifiers, including a plurality of point-of-interest identifiers such as an escape point, an airdrop supply, a stronghold, and a castle. However, the foregoing method is usually disordered as a result of excessive elements on a map, which does not help express a subordination relationship and help the player understand a correspondence, thereby having poor map readability.

In the virtual scene-based identifier prompting method provided in the embodiments of this application, a virtual scene in which a primarily controlled virtual object is located in a virtual battle is displayed. A virtual map configured to represent a scene distribution of the virtual scene is displayed in response to a map viewing operation, the virtual map including at least one first point-of-interest identifier, the first point-of-interest identifier being configured for representing a position of a first point of interest in the virtual scene, and the first point of interest being configured for implementing a function that the virtual object evacuates the virtual scene. A second point-of-interest identifier and an association indication identifier are displayed in response to receiving a trigger operation on the first point-of-interest identifier, the second point-of-interest identifier being configured for representing a position of a second point of interest in the virtual scene, a correspondence existing between the first point of interest and the second point of interest, and the second point of interest being configured for controlling a functional status of the first point of interest. The first point-of-interest identifier is triggered to display the second point-of-interest identifier and the association indication identifier, to clearly present the correspondence between the first point-of-interest identifier and the second point-of-interest identifier, which simplifies elements in the virtual map, and avoids a problem that excessive elements are presented on the virtual map, and causes data interference to a user, thereby improving readability of the virtual map.

First, a virtual scene running system in this application is described. FIG. 2 is a schematic diagram of a virtual scene running system according to an exemplary embodiment of this application. The virtual scene running system includes a terminal 210.

In some embodiments, at least one of a game application, a game client, and a browser is installed on the terminal 210, and the foregoing game application program, the game client, or the browser is configured to run a virtual game. In this embodiment of this application, the virtual game may be any one of games such as a simulation program, a battle royale shooting game, a virtual reality (VR) game, an augmented reality (AR) game, a three-dimensional map game, a first-person shooting game (FPS), a multiplayer shootout survival game, a third-person shooting game (TPS), a multiplayer online battle arena game, and a simulation game (SLG). In this embodiment, a description is provided by using an example in which the virtual game is the multiplayer shootout survival game.

In some embodiments, the terminal 210 runs the virtual game through the game application, or the game client, or the browser, to display the virtual scene. The virtual scene is a scene in which a primarily controlled virtual object of the terminal 210 is located in a virtual battle. A virtual map is displayed in response to a map viewing operation, the virtual map being configured to represent a scene distribution of the virtual scene, the virtual map including at least one first point-of-interest identifier, the first point-of-interest identifier being configured for representing a position of a first point of interest in the virtual scene, and the first point of interest being configured for implementing a function that the virtual object evacuates the virtual scene. A second point-of-interest identifier and an association indication identifier are displayed in response to receiving a trigger operation on the first point-of-interest identifier, the second point-of-interest identifier being configured for representing a position of a second point of interest in the virtual scene, a correspondence existing between the first point of interest and the second point of interest, the association indication identifier being configured for indicating the correspondence, and the second point of interest being configured for controlling a functional status of the first point of interest.

Exemplarily, the multiplayer shootout survival game is used as an example. The virtual battle may be a single-round multiplayer shootout, a virtual environment may be a virtual survival environment in which the primarily controlled virtual object is located in the virtual battle, and the first point of interest may be an evacuation point and is configured for implementing an evacuation function. In other words, the virtual object in the virtual battle may end through the first point of interest and leave a current battle carrying a virtual resource obtained from the current battle. The second point of interest may be an auxiliary function point of the first point of interest and is configured for controlling the functional status of the first point of interest, for example, controlling enabling or disabling of the evacuation point. An example in which the second point of interest is implemented as a gate-pulling point is used. The first point of interest is used as the evacuation point. The virtual object needs to first arrive at the gate-pulling point to perform gate-pulling interaction and open the evacuation point, so that the virtual object may leave the current battle through the evacuation point.

In some embodiments, the second point-of-interest identifier is displayed with different display effects based on different states of the second point of interest. Exemplarily, when the virtual object does not exist within a first area range of a historical time range, the second point-of-interest identifier is displayed with a first display effect. When the virtual object exists within the first area range of the historical time range, the second point-of-interest identifier is displayed with a second display effect. The first area range is an area range corresponding to a position of the first point of interest in the virtual scene. The virtual object may be a primarily controlled virtual object, or may be a virtual object mainly controlled by another terminal, for example, a virtual object located in the same camp or the same group of teams with the primarily controlled virtual object of the terminal 210.

In some embodiments, the virtual scene running system further includes a server 220 and a terminal 230.

A connection relationship is respectively established between the terminal 210 and the terminal 230 and the server 220. The server 220 is configured to provide a virtual game service. The terminal 210 and the terminal 230 run the virtual game by accessing the server 220. In some embodiments, the server 220 records account information, real-time operating data, historical operating data, and the like of a plurality of terminals in a virtual game process. Exemplarily, a primarily controlled virtual object of the terminal 230 and a primarily controlled virtual object of the terminal 210 are in the same virtual battle. If the primarily controlled virtual object of the terminal 230 enters the first area range of the historical time range, the server 220 records the situation and instructs the terminal 210 to display the second point-of-interest identifier with the second display effect.

The foregoing terminal is exemplary. The terminal may be a terminal device in a plurality of forms such as a desktop computer, a laptop computer, a mobile phone, a tablet computer, a wearable device, an e-book reader, a moving picture experts group audio layer III (MP3) player, a moving picture experts group audio layer IV (MP4) player, a smart television, and a smart on-board device, which is not limited in this embodiment of this application.

The foregoing server may be an independent physical server, or may be a server cluster or a distributed system formed by a plurality of physical servers, or may be a cloud server that provides basic cloud computing services such as a cloud service, cloud security, a cloud database, cloud computing, a cloud function, cloud storage, a network service, cloud communication, a middleware service, a domain name service, a security service, a content delivery network (CDN), and a big data and artificial intelligence (AI) platform.

The cloud technology is a hosting technology that unifies a series of resources such as hardware, software, and a network in a wide area network or a local area network to implement calculation, storage, processing, and sharing of data.

In some embodiments, the foregoing server may further be implemented as a node in a blockchain system.

Information (including but not limited to user device information and user personal information), data (including but not limited to data for analysis, stored data, and displayed data), and signals involved in this application are all authorized by users or fully authorized by all parties, and collection, use, and processing of relevant data need to comply with relevant laws, regulations, and standards of relevant countries and regions. For example, operation data and account information involved in this application are obtained with full authorization.

Further, in this application, a prompt interface or a pop-up window may be displayed, or voice prompt information may be outputted before and during collecting user-related data (for example, account information, historical operation data, and real-time operation data involved in this application). The prompt interface, the pop-up window, or the voice prompt information is configured for prompting that relevant data of the user is being collected currently, so that this application starts the relevant operations of obtaining user-related data only after obtaining a confirm operation performed by the user on the prompt interface or the pop-up window, or otherwise (i.e., when the confirm operation performed by the user on the prompt interface or the pop-up window is not obtained), the relevant operations of obtaining user-related data are ended, i.e., the user-related data is not obtained. In other words, all user data collected in this application is collected with the consent and authorization of the user, and the collection, use, and processing of relevant user data need to comply with relevant laws, regulations, and standards of relevant countries and regions.

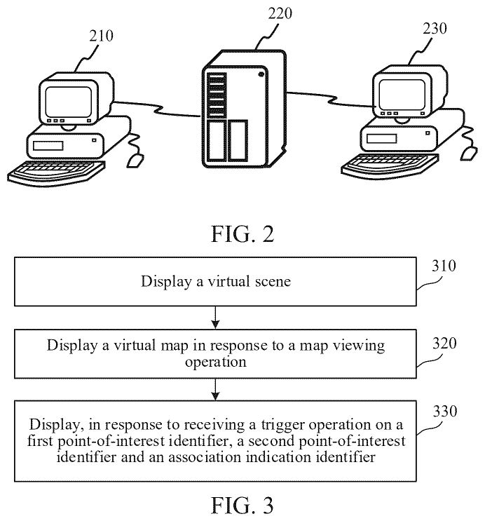

Exemplarily, FIG. 3 is a flowchart of a virtual scene-based identifier prompting method according to an exemplary embodiment of this application. The method may be applied to a terminal, a server, or both a terminal and a server. In this embodiment of this application, a description is provided by using an example in which the method is applied to the terminal. As shown in FIG. 3, the method includes the following operations.

Operation 310: Display a virtual scene.

The virtual scene includes a primarily controlled virtual object. Exemplarily, the virtual scene is a scene in which the primarily controlled virtual object is located in a virtual battle.

In some embodiments, the virtual scene is a virtual scene displayed (or provided) when an application runs on a terminal. The virtual scene may be a simulated world of a real world, or may be a semi-simulation and semi-fiction three-dimensional world, and may further be a purely fictional three-dimensional world. The virtual scene may be any one of a two-dimensional virtual scene, a 2.5-dimensional virtual scene, and a three-dimensional virtual scene. In some embodiments, the virtual scene may be further configured for a virtual scene battle between at least two virtual objects. The virtual scene has virtual resources available for the at least two virtual objects.

In some embodiments, the virtual object refers to a movable object or an immovable object in the virtual scene. The movable object may be at least one of a virtual character, a virtual animal, and a cartoon character. The immovable object may be at least one of a virtual building, a virtual plant, or a virtual terrain. In some embodiments, when the virtual scene is the three-dimensional virtual scene, the virtual object may be a three-dimensional virtual model. Each virtual object has a shape and a volume in the virtual scene, and occupies a part of space in the virtual scene. An activity of the virtual object includes but is not limited to at least one of adjusting a body posture, crawling, walking, running, riding, flying, jumping, driving, picking, shooting, attacking, and throwing. In some embodiments, the virtual object is a three-dimensional character constructed based on a three-dimensional human skeleton technology. The virtual object implements a different external image by wearing a different skin. In some implementations, the virtual object may also be implemented through a 2.5-dimensional model or 2-dimensional model, which is not limited in the embodiments of this application. Exemplarily, based on different manners of controlling the virtual objects, the virtual objects may be divided into a user-controlled virtual object and a server-controlled virtual object. The user-controlled virtual object is an object that is controlled by a client and that may move in the virtual scene. The server-controlled virtual object is a virtual object controlled by an automatic control algorithm or an AI program on the client or the server. The server-controlled virtual object includes the movable object and the immovable object in the virtual scene. Exemplarily, the immovable object may respond to or affect an activity of the movable object. For example, the movable object may destroy the immovable object, or when the movable object enters the immovable object, the movable object enters an invisible state. Exemplarily, the virtual object in this application is a virtual object controlled by the client.

In some embodiments, the virtual scene includes but is not limited to at least one display method of displaying based on a perspective range of the primarily controlled virtual object, performing global display based on a panorama of the virtual scene, or performing display based on a display operation or movement of the terminal.

In some embodiments, the displaying based on a perspective range of the primarily controlled virtual object may be displaying a virtual scene within the perspective range of the virtual object at a first-person perspective, a third-person perspective, or the like of the primarily controlled virtual object. The performing global display based on a panorama of the virtual scene may be displaying a complete virtual scene at a perspective such as a top view of the virtual scene. The performing display based on a display operation or movement of the terminal may be displaying a corresponding virtual scene following a display operation such as a direction of mouse movement of a user. Alternatively, for example, the terminal is implemented as a head mounted VR device, a virtual scene within a corresponding perspective range is displayed following movement of a head of a user.

In some embodiments, the virtual scene is displayed in a form of an interface, and a game element, such as an icon or a control, configured for helping a user play a game or receive an interaction operation is displayed in the virtual scene interface in an overlaid manner.

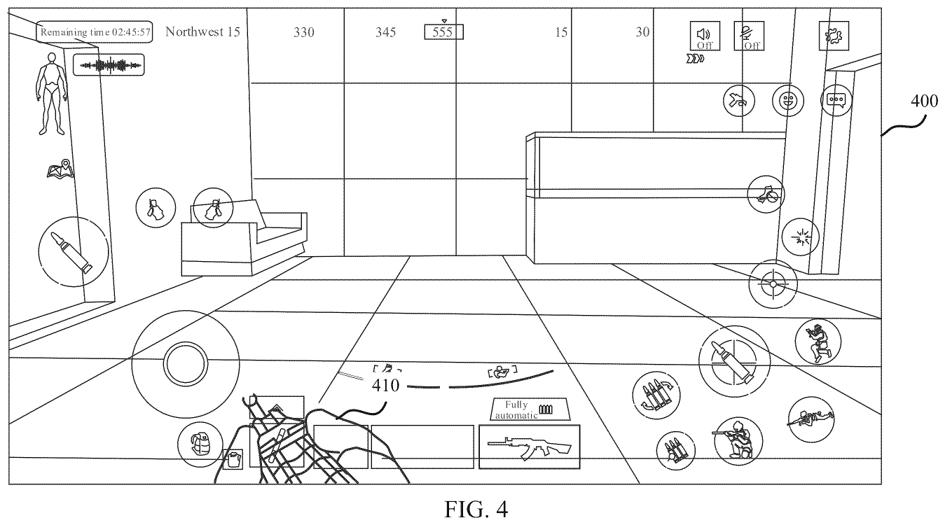

Exemplarily, FIG. 4 is a schematic diagram of a virtual scene according to an exemplary embodiment of this application. As shown in FIG. 4, a virtual scene 400 is displayed with a first-person perspective range of a primarily controlled virtual object 410. The virtual scene 400 is a virtual survival scene of the primarily controlled virtual object 410 in a virtual shootout battle.

Operation 320: Display a virtual map in response to a map viewing operation.

The virtual map is configured to represent a scene distribution of the virtual scene, the virtual map includes at least one first point-of-interest identifier, the first point-of-interest identifier is configured for representing a position of a first point of interest in the virtual scene, and the first point of interest is configured for implementing a function that the virtual object evacuates the virtual scene.

In some embodiments, when a plurality of first points of interest exist in the virtual scene, the first point-of-interest identifiers corresponding to all the first points of interest may be displayed in the virtual map, or the first point-of-interest identifiers corresponding to some of the first points of interest may be displayed. For example, a first point-of-interest identifier corresponding to a first point of interest closest to the primarily controlled virtual object is displayed, or a first point-of-interest identifier corresponding to a first point of interest whose distance to the primarily controlled virtual object is within a preset distance range is displayed, or a first point-of-interest identifier corresponding to a first point of interest whose camp in which the primarily controlled virtual object is located is located has reached is displayed.

In some embodiments, the virtual map may be a panoramic map of the virtual scene configured to represent all scene distributions of the virtual scene, or may be a local map of the virtual scene configured to represent a scene distribution of some areas in the virtual scene. In some embodiments, the virtual scene is divided into a plurality of areas based on a preset area range, or divided into a plurality of scenes based on a preset scene category. When the virtual map is implemented as the local map of the virtual scene, the local map corresponding to an area in which the primarily controlled virtual object is located may be displayed based on the preset area range, or the local maps respectively corresponding to scenes in which all virtual objects are located in a camp in which the primarily controlled virtual object is located may be displayed based on the preset scene category, or the local map corresponding to an area or scene that the primarily controlled virtual object or the camp in which the primarily controlled virtual object is located has reached within the historical time range may be displayed, or the local map corresponding to the selected area or scene may be displayed based on a selection operation of the primarily controlled virtual object.

In some embodiments, the map viewing operation includes, but is not limited to, at least one of a trigger operation on the virtual map, inputting a voice instruction configured for viewing the virtual map, and performing a preset gesture action on an interface of the terminal.

In some embodiments, the primarily controlled virtual object participates in the virtual battle, and the first point of interest is configured for implementing a function of that the virtual object evacuates the virtual scene in the virtual battle.

Exemplarily, the virtual battle corresponds to the virtual scene. The primarily controlled virtual object may evacuate the virtual scene through the first point of interest, which represents that the primarily controlled virtual object may leave the virtual battle though the first point of interest.

In some embodiments, the first point of interest is configured for implementing a function that the virtual object in the virtual battle carries a virtual resource to out of the virtual scene. The virtual resource includes a resource obtained by the virtual object from the virtual battle.

In some embodiments, the virtual resources may be a virtual attack prop, a virtual defense prop, a virtual gold coin, a virtual device, or the like.

In some embodiments, the virtual resource that is carried out of the virtual battle through the first point of interest further includes a resource that is carried when the virtual object enters the virtual battle and that is not currently consumed.

Exemplarily, the first point of interest is implemented as an evacuation point and is configured to implement an evacuation function. In other words, the virtual object in the virtual battle is enabled to out of a virtual scene corresponding to a current battle. When the evacuation point is in an open state, the virtual object in the virtual battle may end and leave the current battle by reaching the evacuation point and performing evacuation interaction with the evacuation point, carrying a virtual prop obtained in the current virtual battle, or the like.

The first point of interest not only may assist the virtual object in evacuating the virtual scene, but also may assist the virtual object in taking the virtual resource obtained from the virtual battle and taking the virtual resource carried into the virtual battle out of the virtual scene. In this way, a resource settlement process can be implemented out of the virtual battle, which avoids a problem of inefficiency of virtual resource settlement during a game process, and a user is helped participate in a virtual resource obtaining process more actively during the virtual battle, thereby enhancing game participation of a player and improving human-computer interaction efficiency while improving interesting of a game.

In some embodiments, the evacuation function of the first point of interest is configured for determining a success of the virtual battle.

Exemplarily, in a single-round virtual battle, the camp where the virtual object is out of the current battle from the first point of interest wins first.

In some embodiments, the first point of interest may further be implemented as a functional point such as a recovery point, a transmission point, a shopping point, or a sneaking point, and correspondingly, is configured to implement a recovery function, a transmission function, a prop obtaining function, a function of sneaking into a preset area, or the like. The first point-of-interest identifier is configured for representing a position of the foregoing functional point in the virtual scene on the virtual map. The foregoing functions are merely exemplary examples. The first point of interest is not limited in this application. In the embodiments of this application, a description is provided by using an example in which the first point of interest is configured for implementing the evacuation function.

In some embodiments, when the first point of interest is in an unknown state, the first point-of-interest identifier is displayed on the virtual map with a preset unknown effect, or when the first point of interest is in a known state, the first point-of-interest identifier is displayed on the virtual map with a preset known effect. In some embodiments, if the object does not exist within the first area range of the historical time range, the first point of interest is in the unknown state, or if the virtual object within the first area range of the historical time range exists, the first point of interest is in the known state. The first area range is an area range corresponding to a position of the first point of interest in the virtual scene.

In some embodiments, the virtual object may be a virtual object of a camp in which the primarily controlled virtual object is located, or may be a virtual object of a rival camp of the primarily controlled virtual object, or the like.

In some embodiments, the known state includes an evacuation-allowed state and an evacuation-prohibited state, and the evacuation-allowed state and the evacuation-prohibited state are implementation forms of the functional status corresponding to the first point of interest. The known effect corresponding to the known state includes an available effect and an unavailable effect.

In some embodiments, when the first point of interest is in the evacuation-allowed state, the first point-of-interest identifier is displayed in the virtual map with a preset available effect, or when the first point of interest is in the evacuation-prohibited state, the first point-of-interest identifier is displayed in the virtual map with a preset unavailable effect. That the first point of interest is in the evacuation-allowed state means that the first point of interest may currently perform the evacuation function, and that the first point of interest is in the evacuation-prohibited state means that the first point of interest cannot currently perform the evacuation function. Exemplarily, when the first point of interest is in the evacuation-allowed state, the first point-of-interest identifier corresponding to an available first point of interest is displayed in the virtual map with a green state. When the first point of interest is in the evacuation-prohibited state, the first point-of-interest identifier corresponding to an unavailable first point of interest is displayed in the virtual map with a red state.

In some embodiments, different display effects corresponding to different states of the first point of interest may be configured. In other words, the user may configure the foregoing unknown effect, the known effect, the available effect, and the unavailable effect. A display scheme of the first point of interest may also be configured. In other words, the user may configure that the first point of interest is always displayed with the same display effect, or may configure that the first point of interest is displayed based on different states with different display effects.

In some embodiments, a plurality of first points of interest exist, and at least one first point of interest is preset to be in the evacuation-prohibited state. When the unavailable first point of interest meets a function enabling condition, the unavailable first point of interest is converted into the evacuation-allowed state. In some embodiments, at least one first point of interest that is in the evacuation-allowed state exists. When the available first point of interest meets a function disabling condition, the available first point of interest is converted into the evacuation-prohibited state.

In some embodiments, the function enabling condition and the function disabling condition may be conditions preset by a system, or may be conditions formulated by the user based on the single-round virtual battle. For example, before the single-round virtual battle starts, a user controlling the primarily controlled virtual object selects at least one preset condition from a plurality of preset conditions provided by the system as the function enabling condition or the function disabling condition, or all users participating in a battle vote for the plurality of preset conditions or user-defined conditions provided by the system, and selects a condition that is the highest in ticket before the battle starts as the function enabling condition or the function disabling condition.

In some embodiments, the function enabling condition may be implemented as the following. A virtual battle duration reaches a preset duration range, a score of the primarily controlled virtual object or the camp in which the primarily controlled virtual object is located exceeds a preset score threshold, an attached point of interest that is configured to control the functional status of the first point of interest is triggered, the rival camp of the primarily controlled virtual object is eliminated, a quantity of virtual objects arriving at the position of the first point of interest within the historical time range reaches a preset quantity threshold, and the like.

In some embodiments, the function disabling condition may be implemented as the following. A duration in which the first point of interest is in the evacuation-allowed state reaches the preset duration range, a quantity of surviving persons in the camp in which the primarily controlled virtual object is located is less than a preset quantity, the rival camp of the primarily controlled virtual object reaches the first point of interest before the camp in which the primarily controlled virtual object is located, a quantity of virtual objects performing the evacuation function through the first point of interest within the historical time range exceeds a preset quantity range, and the like.

The foregoing function enabling condition and the function disabling condition are merely exemplary examples, which are not limited in this application.

In some embodiments, the first point-of-interest identifier corresponds to a first detail area, and the first detail area is configured to allow displaying of first information of the first point of interest. In some embodiments, the first information includes, but is not limited to, position information, function information, the functional status, the function enabling condition, the function disabling condition, and the like of the first point of interest.

In some embodiments, the first detail area may be displayed along with the first point-of-interest identifier. In other words, the virtual map is displayed in response to the map viewing operation, the virtual map includes the first point-of-interest identifier and the first detail area corresponding to the first point-of-interest identifier. Alternatively, the first detail area may be displayed in response to the trigger operation on the first point-of-interest identifier.

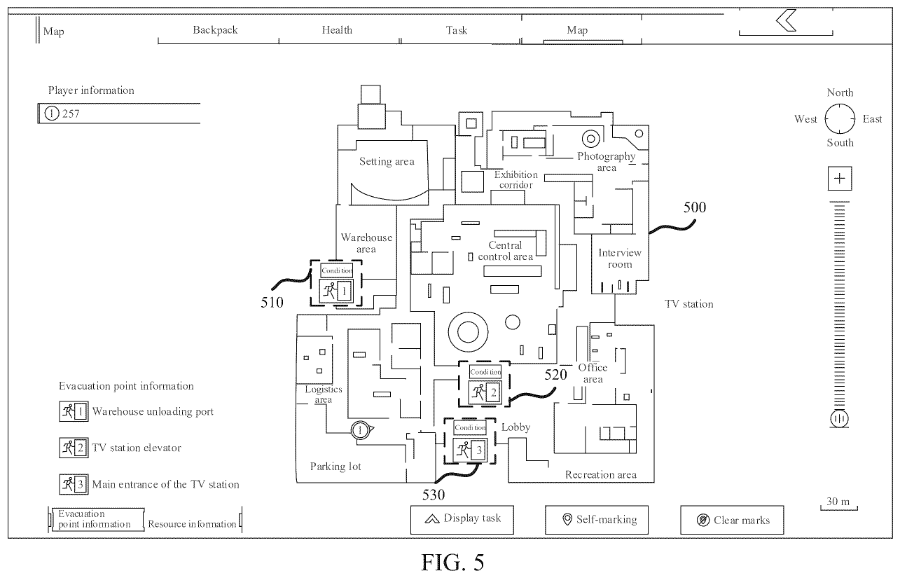

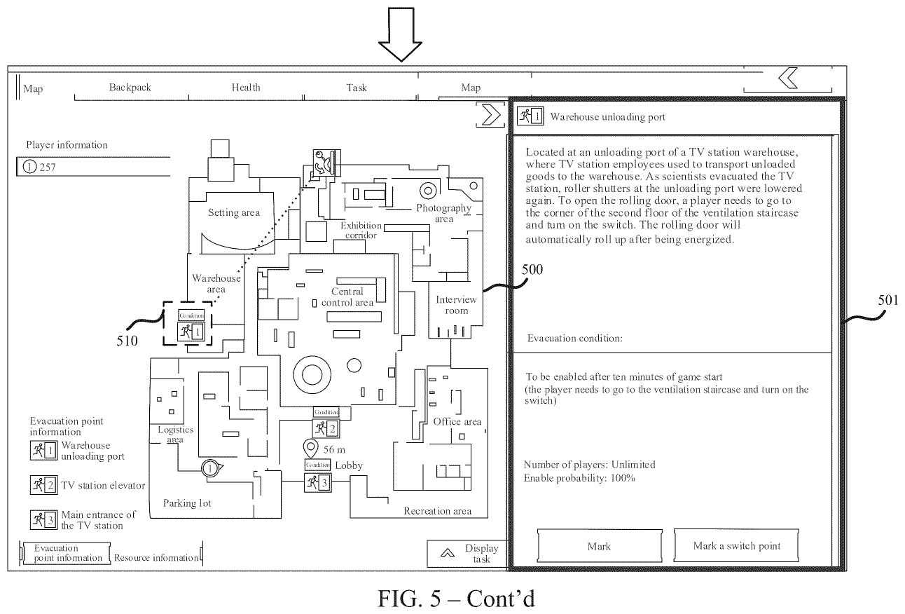

Exemplarily, FIG. 5 is a schematic diagram of a virtual map according to an exemplary embodiment of this application. As shown in FIG. 5, a virtual map 500 is displayed in response to a map viewing operation. The virtual map 500 includes a first point-of-interest identifier 510, a first point-of-interest identifier 520, and a first point-of-interest identifier 530, which are respectively configured to represent positions of a first point of interest 1, a first point of interest 2, and a first point of interest 3 in a virtual scene. The first point of interest 1, the first point of interest 2, and the first point of interest 3 are all configured to implement an evacuation function. A first detail area 501 is displayed in response to a trigger operation on the first point-of-interest identifier 510. The first detail area 501 is configured to allow displaying of first information of the first point of interest 1.

Operation 330: Display, in response to receiving a trigger operation on a first point-of-interest identifier, a second point-of-interest identifier and an association indication identifier.

The second point-of-interest identifier is configured for representing a position of a second point of interest in the virtual scene, a correspondence exists between the first point of interest and the second point of interest, and the association indication identifier is configured for indicating the correspondence, and the second point of interest being configured for controlling a functional status of the first point of interest.

In some embodiments, the second point-of-interest identifier and the association indication identifier are displayed on the virtual map in response to receiving the trigger operation on the first point-of-interest identifier.

Exemplarily, the point-of-interest identifiers are displayed on the virtual map. When the trigger operation is performed on the first point-of-interest identifier, the second point-of-interest identifier may be displayed on the virtual map, to represent a position of the second point of interest corresponding to the second point of interest through the second point-of-interest identifier relative to the virtual map.

In some embodiments, the functional status includes an evacuation-allowed state and an evacuation-prohibited state. A description is provided by using an example in which the first point of interest is implemented as an evacuation point. The second point of interest may control enabling or disabling of the evacuation point. Enabling of the evacuation point is the evacuation-allowed state, indicating that an evacuation function can be executed. Disabling of the evacuation point is the evacuation-prohibited state, indicating that an evacuation function cannot be currently executed.

In some embodiments, the second point of interest may further set or adjust a configuration of the first point of interest, which includes, but is not limited to, setting of a startup duration, setting of a visual state, setting of a functional restriction, and the like. Exemplarily, the startup duration of the first point of interest may be set or adjusted through the second point of interest. For example, it is set that the first point of interest is automatically started after being timed for 1 minute since an interaction operation between the first point of interest and the second point of interest is completed. The visual state of the first point of interest may be set or adjusted through the second point of interest. For example, a transparency of the first point of interest to a camp in which the primarily controlled virtual object is located is set to 0%, and a transparency of the first point of interest to a rival camp of the primarily controlled virtual object is set to 100%. In other words, the first point of interest is set to be visible only to the camp in which the primarily controlled virtual object is located. The functional limitation of the first point of interest is set through the second point of interest. For example, the evacuation function of the first point of interest is set to be available only to the camp in which the primarily controlled virtual object is located, or a threshold of a quantity of virtual objects for performing the evacuation function through the first point of interest is set.

In some embodiments, a correspondence between the first point of interest and the second point of interest may be one-to-one, one-to-many, or many-to-one. In other words, one first point of interest corresponds to one second point of interest. Alternatively, one first point of interest corresponds to a plurality of second points of interest, and the virtual object may control a functional status of a corresponding first point of interest through any one of the plurality of second points of interest. Alternatively, the plurality of first points of interest correspond to one second point of interest, and the functional statuses of the plurality of corresponding first points of interest through the one second point of interest may be simultaneously controlled by the virtual object.

In some embodiments, based on the foregoing one-to-one, or one-to-many, or many-to-one correspondence, operation 330 has the following three cases.

First, displaying, in response to receiving the trigger operation on the first point-of-interest identifier, a single second point-of-interest identifier and a single association indication identifier on the virtual map.

Exemplarily, a one-to-one correspondence exists between the first point of interest A and the second point of interest B. In response to receiving a trigger operation on the first point-of-interest identifier a corresponding to the first point of interest A, the second point-of-interest identifier b corresponding to the second point of interest b and the association indication identifier c configured to connect the first point-of-interest identifier a to the second point-of-interest identifier b are displayed on the virtual map.

Second, displaying, in response to receiving the trigger operation on the first point-of-interest identifier, a plurality of second point-of-interest identifiers and a plurality of association indication identifiers on the virtual map.

Exemplarily, a one-to-many correspondence exists between the first point of interest A, the second point of interest B, and a second point of interest C. The virtual object may control a functional status of the first point of interest A through the second point of interest B, or may control the functional status of the first point of interest A through the second point of interest C. In response to receiving the trigger operation on the first point-of-interest identifier a corresponding to the first point of interest A, the second point-of-interest identifier b corresponding to the second point of interest b, the second point-of-interest identifier c corresponding to the second point of interest c, an association indication identifier d configured to connect the first point-of-interest identifier a to the second point-of-interest identifier b, and an association indication identifier e configured to connect the first point-of-interest identifier a to the second point-of-interest identifier c are displayed on the virtual map.

Third, displaying, in response to receiving the trigger operation on the first point-of-interest identifier, a single second point-of-interest identifier and a plurality of association indication identifiers on the virtual map.

Exemplarily, a many-to-one correspondence exists between the first point of interest A, the first point of interest B, the first point of interest C, and the second point of interest D. The functional statuses of the first point of interest A, the first point of interest B, and the first point of interest C may be simultaneously controlled by the virtual object through the second point of interest D. In response to receiving the trigger operation on the first point-of-interest identifier a corresponding to the first point of interest A, the second point-of-interest identifier d corresponding to the second point of interest d, an association indication identifier x configured to connect the first point-of-interest identifier a to the second point-of-interest identifier d, an association indication identifier y configured to connect the first point-of-interest identifier b to the second point-of-interest identifier d, and an association indication identifier z configured to connect the first point-of-interest identifier c to the second point-of-interest identifier d are displayed on the virtual map.

In some embodiments, the foregoing correspondence may be preset by a system, or may be configured by a user.

In some embodiments, the foregoing display scheme may be configured. Using the many-to-one correspondence as an example, the user may configure, after the first point-of-interest identifier is triggered, only to display the corresponding second point-of-interest identifier and the association indication identifier between the second point-of-interest identifier and the triggered first point-of-interest identifier, or may configure, after the first point-of-interest identifier is triggered, to display an association indication identifier between the second point-of-interest identifier and another corresponding first point-of-interest identifier while displaying the association indication identifier between the second point-of-interest identifier and the triggered first point-of-interest identifier.

In some embodiments, the association indication identifier may be implemented as a connection line, an arrow, or the like between the first point-of-interest identifier and the second point-of-interest identifier.

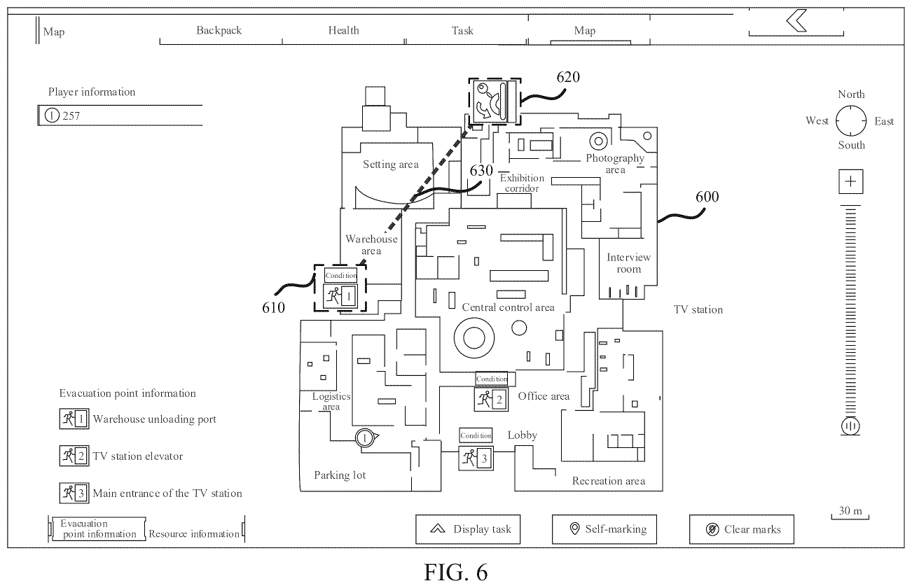

Exemplarily, FIG. 6 is a schematic diagram of a second point-of-interest identifier and an association indication identifier according to an exemplary embodiment of this application. As shown in FIG. 6, a second point-of-interest identifier 620 and an association indication identifier 630 are displayed on a virtual map 600 in response to receiving a trigger operation on a first point-of-interest identifier 610.

A second point-of-interest identifier corresponding to a second point of interest attached to a first point of interest are displayed on a virtual map through a trigger operation on the first point-of-interest identifier based on a correspondence between the first point of interest and the second point of interest. Based on a difference between a quantity of correspondences, a corresponding quantity of second point-of-interest identifiers may be displayed. For example, a single second point-of-interest identifier or a plurality of second point-of-interest identifiers is displayed. In addition, based on meanings of the association indication identifiers, different quantities of association indication identifiers may further be displayed when the second point-of-interest identifier is displayed. The quantity of second point-of-interest identifiers and the quantity of association indication identifiers are briefly described with the help of the foregoing content, to fully describe an implementation of the point-of-interest identifiers and an implementation of the association indication identifiers, and enrich representation content of the correspondence between the first point of interest and the second point of interest.

In some embodiments, the second point-of-interest identifier is displayed with different display effects based on different states of the second point of interest. In some embodiments, a display manner of the second point-of-interest identifier includes the following two cases.

First, displaying, in response to the trigger operation on the first point-of-interest identifier when the virtual object does not exist within a second area range of a historical time range, the second point-of-interest identifier and the association indication identifier on the virtual map with a first display effect.

The second area range is an area range corresponding to a position of the second point of interest in the virtual scene.

In some embodiments, when the object does not exist within the first area range of the historical time range, the second point of interest is in an unknown state. In other words, no virtual object reaches the second point of interest within the historical time range.

In some embodiments, the foregoing virtual object may be a primarily controlled virtual object or another virtual object. The another virtual object may be a virtual object having an association relationship with the primarily controlled virtual object, for example, a virtual object in the same camp or a virtual object in a rival camp.

In some embodiments, the first display effect is configured for conveying to a user that the second point of interest is in an unknown state. In some embodiments, the first display effect may be a preset color halo effect, a question mark identifier effect, or the like.

Second, displaying, in response to the trigger operation on the first point-of-interest identifier when the virtual object exists within the second area range of the historical time range, the second point-of-interest identifier and the association indication identifier on the virtual map with a second display effect.

In some embodiments, when the virtual object exists within the second area range of the historical time range, the second point of interest is in the known state. In other words, the virtual object already reaches the second point of interest within the historical time range.

In some embodiments, the foregoing virtual object may be a primarily controlled virtual object or another virtual object. The another virtual object may be a virtual object having an association relationship with the primarily controlled virtual object, for example, a virtual object in the same camp or a virtual object in a rival camp.

An existing situation of the virtual object within the second area range of the historical time range is used as a condition for distinguishing the display effect, so that the second point-of-interest identifier and the association indication identifier may be distinguished with the first display effect or the second display effect. Because the second area range is an area range corresponding to a position of the second point of interest, in this manner, a player may be helped to learn, based on a difference in display effects, an existing situation of the virtual object at a current second point of interest, so that the player adaptively adjusts a game policy for reaching the second point of interest. In this way, the virtual object may be prevented from attacking the primarily controlled virtual object to some extent, thereby enriching a picture display effect, and improving game experience of the player.

In some embodiments, the known state of the second point of interest includes an enabled state and a disabled state, and the second display effect includes a third display effect and a fourth display effect.

In some embodiments, the association indication identifier is displayed on the virtual map when the second point of interest is in the enabled state, and the second point-of-interest identifier is displayed with the third display effect. Alternatively, the association indication identifier is displayed on the virtual map when the second point of interest is in the disabled state, and the second point-of-interest identifier is displayed with the fourth display effect.

The enabled state is configured for controlling the functional status to be implemented as an evacuation-allowed state indicating that the primarily controlled virtual object evacuates through the first point of interest; and the disabled state is controlling the functional status to be implemented as an evacuation-prohibited state indicating that the primarily controlled virtual object is unable to evacuate through the first point of interest.

Exemplarily, when the second point of interest is in the enabled state, the primarily controlled virtual object may evacuate the virtual scene through the first point of interest. In other words, the functional status corresponding to the first point of interest is implemented as the evacuation-allowed state. When the second point of interest is in the disabled state, the primarily controlled virtual object may not evacuate the virtual scene through the first point of interest. In other words, the functional status corresponding to the first point of interest is implemented as the evacuation-prohibited state.

Exemplarily, when no virtual object reaches the second point of interest within the historical time range, the second point-of-interest identifier is displayed with a yellow state, to indicate that the second point of interest belongs to an unknown state. When the virtual object reaches the second point of interest within the historical time range, the second point-of-interest identifier that is in the enabled state is displayed with a green state, and the second point-of-interest identifier that is in the disabled state is displayed with a red state.

In some embodiments, the foregoing schemes of displaying the second point-of-interest identifier with different display effects may be configured. In other words, the user may configure the second point-of-interest identifier to be displayed with two display effects based on the known state and the unknown state, may configure the second point-of-interest identifier to be displayed with three display effects based on the unknown state, the enabled state, and the disabled state, may configure the second point-of-interest identifier to be displayed with two display effects based on the enabled state and the disabled state, may configure the second point of interest to be displayed always with a fixed display effect, or the like.

In some embodiments, the case in which the second point of interest is in the enabled state includes but is not limited to at least one of that the virtual object does not change the functional status of the first point of interest through the second point of interest within the historical time range, that a battle duration reaches a preset duration range, that the primarily controlled virtual object or a camp in which the primarily controlled virtual object is located obtains a score of a preset virtual prop, or the primarily controlled virtual object or a camp in which the primarily controlled virtual object is located reaches a preset score threshold. The case in which the second point of interest is in the disabled state includes but is not limited to at least one of that the virtual object changes the functional status of the first point of interest through the second point of interest within the historical time range, that a battle duration reaches a preset duration range, that the primarily controlled virtual object obtains a score of a preset virtual prop, the primarily controlled virtual object, or a camp in which the primarily controlled virtual object is located is less than a preset score threshold.

When the association indication identifier is displayed, the display effects of the second point-of-interest identifier are displayed differently based on the state of the second point of interest. The second point of interest is used as an attached point of interest that may adjust the functional status of the first point of interest, and may implement different adjustment functions in different states. Therefore, the function implemented by the second point of interest in a current state may be represented more intuitively through different display effects, so that the player may determine, through different display effects corresponding to the second point-of-interest identifier, the function that may be implemented by the current first point of interest, thereby facilitating the primarily controlled virtual object to implement efficient evacuation based on the first point of interest, and improving efficiency of human-computer interaction.

In some embodiments, a second detail area corresponds to the second point-of-interest identifier, and the second detail area is configured to allow displaying of second information of the second point of interest. In some embodiments, the second information includes but is not limited to position information, state information, an available condition, and the like of the second point of interest.

In some embodiments, the second detail area may be displayed along with the second point-of-interest identifier. In other words, the second point-of-interest identifier, the association indication identifier, and the second detail area are displayed on the virtual map in response to receiving the trigger operation on the first point-of-interest identifier. Alternatively, the second detail area may be displayed in response to a trigger operation on the second point-of-interest identifier.

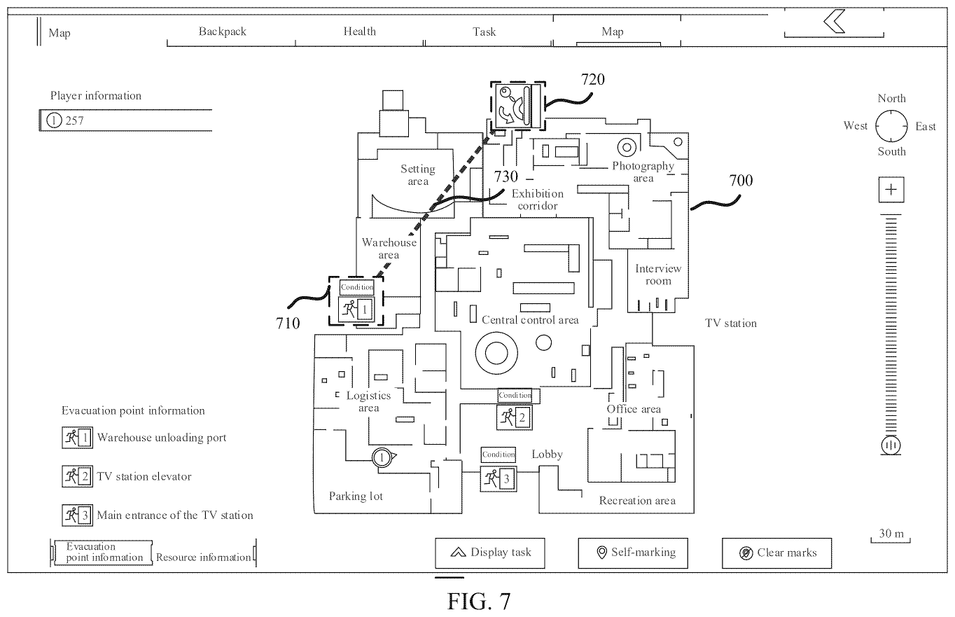

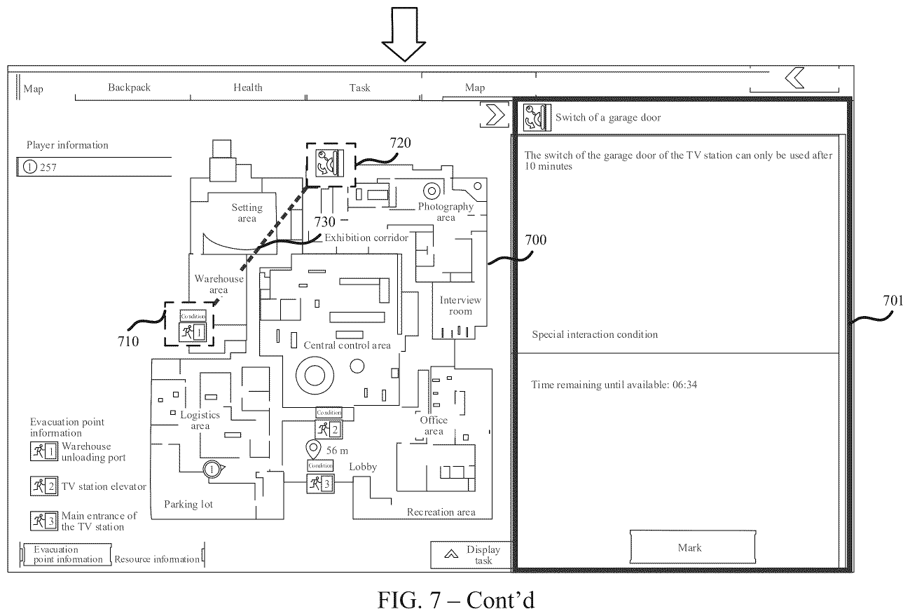

Exemplarily, FIG. 7 is a schematic diagram of a virtual map according to an exemplary embodiment of this application. As shown in FIG. 7, a second point-of-interest identifier 720 and an association indication identifier 730 are displayed on the virtual map 700 in response to receiving a trigger operation on a first point-of-interest identifier 710. The second point-of-interest identifier 720 is configured to represent a position of a second point of interest A in a virtual scene, the association indication identifier 730 is configured to indicate a correspondence between a first point of interest 1 and the second point of interest A, and the second point of interest A is configured to control a functional status of the first point of interest 1. A second detail area 701 is displayed in response to a trigger operation on the second point-of-interest identifier 720. The second detail area 701 is configured to allow displaying of second information of the second point of interest A.

In some embodiments, after the second point-of-interest identifier and the association indication identifier are displayed, a display cancellation process is further included. The process is implemented as: removing the second point-of-interest identifier and the association indication identifier in response to a hiding operation. In some embodiments, the hiding operation includes, but is not limited to, a trigger operation on another point-of-interest identifier, a trigger operation on a blank area, a trigger operation on a hidden control, and the like. The another point-of-interest identifier refers to a point-of-interest identifier on the virtual map other than the first point-of-interest identifier and the second point-of-interest identifier, and the blank area refers to a display area on a terminal interface outside a virtual map.

Exemplarily, after the second point-of-interest identifier and the association indication identifier are displayed, the display process may be canceled through the hiding operation, to avoid a problem that the second point-of-interest identifier and the association indication identifier are continuously displayed on the interface, resulting in interface clutter. By voluntarily selecting to perform the hiding operation, the player can flexibly control content displayed on the interface.

In some embodiments, removing, in response to receiving an area trigger operation for a hidden area as the hiding operation, the second point-of-interest identifier and the association indication identifier.

The hidden area is an area other than a point-of-interest identifier on the virtual map. When the player performs the area trigger operation such as clicking/tapping or pressing and holding on the hidden area, the operation may be considered as removing the hiding operation of the second point-of-interest identifier and the association indication identifier.

In some embodiments, removing, in response to receiving an identifier trigger operation for a third point-of-interest identifier as the hiding operation, the second point-of-interest identifier and the association indication identifier.

A third point of interest corresponding to the third point-of-interest identifier being another point of interest that does not have the correspondence with the first point of interest. Exemplarily, the virtual map includes a plurality of point-of-interest identifiers. The plurality of point-of-interest identifiers include a first point-of-interest identifier and a third point-of-interest identifier that do not have a correspondence. The second point-of-interest identifier may be displayed based on the trigger operation on the first point-of-interest identifier. If the second point-of-interest identifier needs to be undisplayed, the trigger operation may be performed on the third point-of-interest identifier. The trigger operation may undisplay the second point-of-interest identifier, and a fourth point-of-interest identifier that has a correspondence with the third point of interest may further be displayed.

By performing the hiding operation on the hidden area or the third point-of-interest identifier, a diversified process of hiding the point of interest can be implemented, operation manners of the player are enriched, and efficiency of human-computer interaction is improved.

In some embodiments, the first detail area is further displayed in response to the trigger operation on the first point-of-interest identifier. In other words, operation 330 may be implemented as: displaying, in response to receiving the trigger operation on the first point-of-interest identifier, the second point-of-interest identifier and the association indication identifier on the virtual map, and displaying a first detail area corresponding to the first point of interest.

The first detail area is configured to allow displaying of first information of the first point of interest.

Exemplarily, the first information includes, but is not limited to, position information, function information, a functional status, a function enabling condition, a function disabling condition, and the like of the first point of interest, and is information configured for describing a characteristic of the first point of interest.

An attribute of the first point of interest may be described more comprehensively through the first detail area, and the presented first information can assist the player in gaining a more detailed understanding of the first point of interest, to guide the player to perform a more targeted game process based on the first point of interest, thereby helping improve the efficiency of human-computer interaction.

In some embodiments, the first detail area is configured to receive a marking operation on the first point-of-interest identifier, or a marking operation on the second point-of-interest identifier.

In some embodiments, after the first detail area is displayed, a marking effect of the second point of interest is displayed when the marking operation on the second point of interest is received in the first detail area.

The marking effect is configured for representing a result that the second point of interest is marked. In some embodiments, the marking effect is implemented as at least one of a plurality of special effects such as a highlight effect, a shadow effect, and a color effect.

In some embodiments, the marking effect of the second point of interest includes, but is not limited to, a marking effect of a second point-of-interest identifier on the virtual map, a marking effect of the second point of interest in the virtual scene, or the like.

Exemplarily, the first detail area includes a second marking control configured to mark the second point-of-interest identifier. The marking effect of the second point-of-interest identifier is displayed on the virtual map in response to receiving the trigger operation on the second marking control.

In addition to allowing displaying of the first information through the first detail area to describe the first point of interest in detail, the marking operation on the second point of interest may be implemented through the first detail area. While the first detail area is expanded to implement functions, a positioning effect of the second point of interest in the virtual map is enhanced through the marking effect, to help the player explore the point of interest in a targeted manner through the marking effect during the game process, thereby improving game experience and game pleasure of the player. In addition, a problem of a relatively large amount of cached data in an interface caused by performing the marking operation through another interface may be avoided, thereby reducing a data processing amount.

In some embodiments, after the second point-of-interest identifier is displayed, the trigger operation on the second point-of-interest identifier may further be received.

In some embodiments, the second detail area corresponding to the second point-of-interest identifier is displayed in response to receiving the trigger operation on the second point-of-interest identifier.

The second detail area is configured to allow displaying of second information of the second point of interest.

Exemplarily, the second information includes, but is not limited to, position information, function information, a functional status, a function enabling condition, a function disabling condition, and the like of the second point of interest, and is information configured for describing a characteristic of the second point of interest.

In some embodiments, the second detail area is configured to receive the marking operation on the second point of interest.

In some embodiments, the marking operation on the second point of interest is received in the second detail area, and the marking effect of the second point of interest is displayed.

Exemplarily, the second detail area includes a second marking control configured to mark the second point-of-interest identifier. The marking effect of the second point-of-interest identifier is displayed on the virtual map in response to receiving the trigger operation on the second marking control.

Through the second detail area, not only an attribute of the second point of interest may be described more comprehensively, to guide the player to adjust the functional status corresponding to the first point of interest in a targeted manner through the second point of interest based on the second information, but also the second point-of-interest identifier may be marked more rapidly through the second detail area, thereby enriching manners for marking the second point-of-interest identifier, improving flexibility and adaptability of the marking operation, fully aiming at a plurality of interface resources to implement a marking objective, encouraging the player to participate in a process of exploring the point of interest, and enriching the game experience.

Based on the above, the virtual map configured to represent the scene distribution of the virtual scene is displayed through the map viewing operation, and the second point-of-interest identifier and the association indication identifier are displayed based on the trigger operation on the first point-of-interest identifier on the virtual map. A correspondence exists between the first point of interest and the second point of interest, and the second point of interest may control the functional status of the first point of interest. The process of triggering the first point-of-interest identifier to display the second point-of-interest identifier and the association indication identifier may avoid a problem of clutter on interface display because excessive point-of-interest identifiers are displayed on the virtual map. The second point-of-interest identifier is displayed as an attached identifier behind the first point-of-interest identifier, to fully utilize the correspondence between the first point-of-interest identifier and the second point-of-interest identifier. The correspondence may further be embodied through the association indication identifier more clearly and intuitively, thereby simplifying the point-of-interest identifiers on the virtual map, and avoiding a problem of data interference caused by excessive identifiers display on the user. Readability of the virtual map is improved, and efficiency of human-computer interaction is helped improve.

According to the method provided in the embodiments of this application, the second point-of-interest identifier and the association indication identifier are displayed on the virtual map with the first display effect in response to the trigger operation on the first point-of-interest identifier when the virtual object does not exist within the first area range of the historical time range, and the second point-of-interest identifier and the association indication identifier are displayed in the virtual map with the second display effect in response to the trigger operation on the first point-of-interest identifier when the virtual object exists within the first area range of the historical time range. Two display manners of the second point-of-interest identifier and the association indication identifier are clarified. Whether the virtual object appears within the first area range of the historical time range is intuitively presented to the user through different display effects, thereby improving readability of the virtual map.

According to the method provided in the embodiments of this application, the association indication identifier is displayed on the virtual map when the second point of interest is in the enabled state, and the second point-of-interest identifier is displayed with the third display effect. Alternatively, the association indication identifier is displayed on the virtual map when the second point of interest is in the disabled state, and the second point-of-interest identifier is displayed with the fourth display effect. Two display schemes when the second point of interest is in the known state are clarified. Whether the second point of interest is available is intuitively presented to the user through different display effects, thereby improving readability of the virtual map.

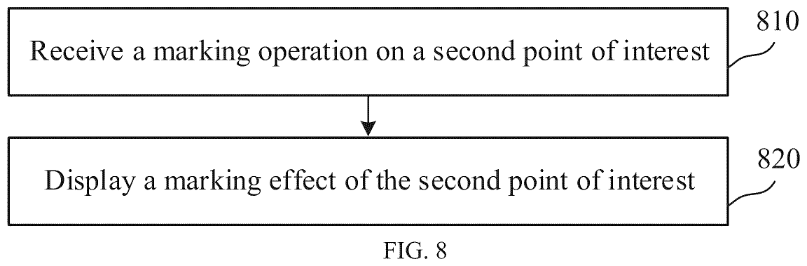

In some embodiments, the virtual scene-based identifier prompting method provided in the embodiments of this application further includes a marking process for a second point of interest. FIG. 8 is a flowchart of a second point-of-interest marking method according to an exemplary embodiment of this application. The method may be applied to a terminal, a server, or both a terminal and a server. In this embodiment of this application, a description is provided by using an example in which the method is applied to the terminal. As shown in FIG. 8, the method includes the following operations.

Operation 810: Receive a marking operation on a second point of interest.

In some embodiments, the marking operation is implemented as a trigger operation on a marking control. In some embodiments, the marking control may be a control in a virtual scene, or may be a control in an interface in which a virtual map is located.

In some embodiments, Operation 810 includes the following two cases.

First, displaying a second point-of-interest marking control in the virtual scene when the primarily controlled virtual object is located within a first area range and the second point of interest is not marked, and receiving a marking operation on the second point-of-interest marking control.

The first area range refers to an area range corresponding to a position of the first point of interest in the virtual scene. For example, a spherical range that uses the position of the first point of interest as a spherical center and a preset length as a radius in the virtual scene is implemented as the first area range.

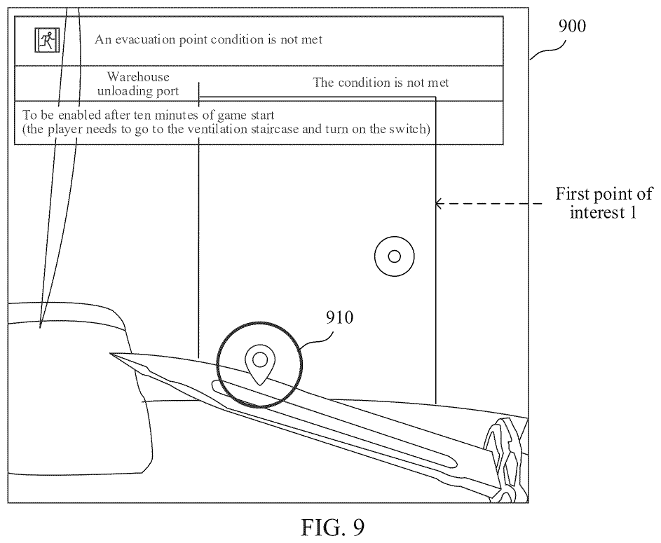

Exemplarily, FIG. 9 is a schematic diagram of a second point-of-interest marking control according to an exemplary embodiment of this application. As shown in FIG. 9, when a primarily controlled virtual object reaches a first area range of the first point of interest 1, a second point-of-interest marking control 910 is displayed in a virtual scene 900 when the second point of interest A is not marked, and a marking operation on a second point-of-interest marking control 910 is received.

The first area range and a case in which the second point of interest is not marked are used as conditions for limiting displaying of the second point-of-interest marking control. When the primarily controlled virtual object is located in the first area range and the second point of interest is not marked, the second point-of-interest marking control configured to mark the second point-of-interest identifier may be displayed, thereby increasing game playability while increasing game challenge. In this way, a player needs to strive for right of marking the point of interest within the first area range as soon as possible, and a marking operation is performed through the second point-of-interest marking control, thereby enriching point-of-interest marking manners and enhancing game interest.

Second, receiving a marking operation on the second point of interest in a detail area of a virtual map when the second point-of-interest identifier is displayed in the virtual map.

The detail area includes a first detail area or a second detail area. The first detail area is configured to allow displaying of first information of the first point of interest, and the second detail area is configured to allow displaying of second information of the second point of interest.

In some embodiments, displaying the second point-of-interest identifier on the virtual map means that a trigger operation on the first point-of-interest identifier is received. In some embodiments, the first detail area is displayed in response to the trigger operation on the first point-of-interest identifier. In some embodiments, based on a correspondence between the first point of interest and the second point of interest, the first detail area includes a second point-of-interest marking control. Alternatively, after the second point-of-interest identifier is displayed, the second detail area is displayed in response to a trigger operation on the second point-of-interest identifier, where the second detail area includes the second point-of-interest marking control.

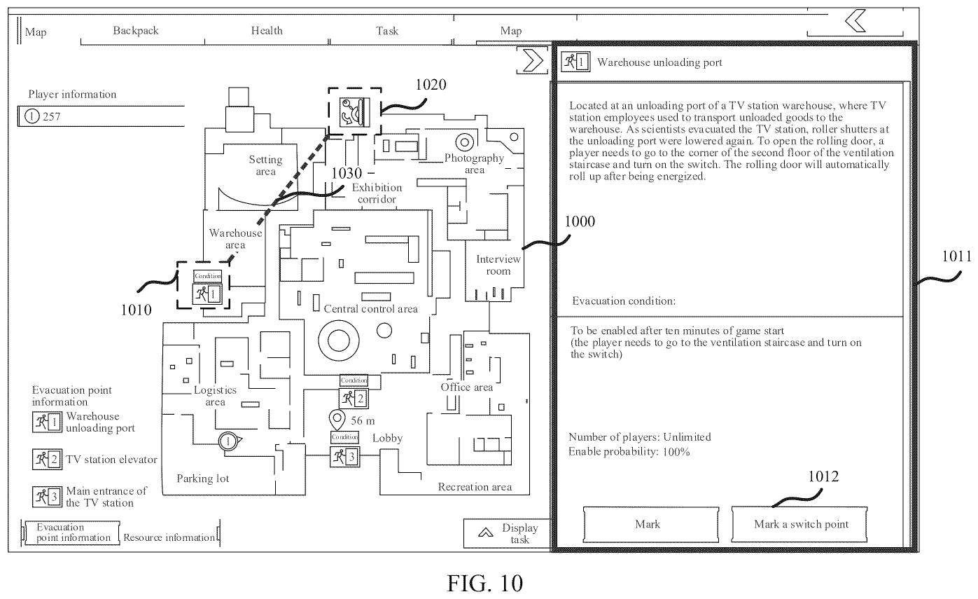

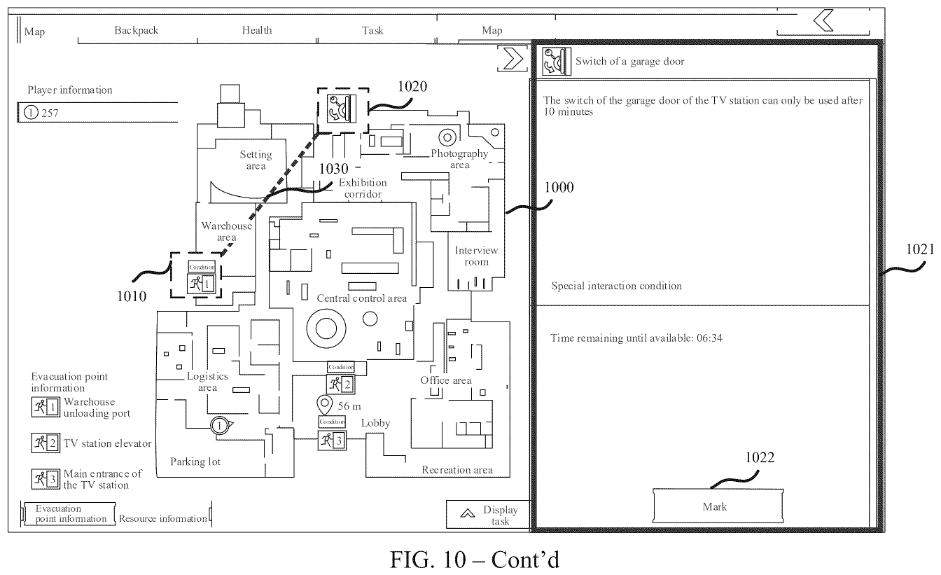

Exemplarily, FIG. 10 is a schematic diagram of a second point-of-interest marking control according to another exemplary embodiment of this application. As shown in FIG. 10, a first detail area 1011, a second point-of-interest identifier 1020, and an association indication identifier 1030 are displayed in a virtual map 1000 in response to a trigger operation on a first point-of-interest identifier 1010, and a marking operation on the second point of interest 1020 is received through a second point-of-interest marking control 1012 in the first detail area 1011. Alternatively, when the second point-of-interest identifier 1020 is displayed in the virtual map 1000, a second detail area 1021 is displayed in response to a trigger operation on the second point-of-interest identifier 1020, and the marking operation on the second point of interest 1020 is received in the second detail area 1021 through a second point-of-interest marking control 1022.

Based on the above, a process of marking the second point of interest includes three schemes, which are respectively: receiving a marking operation on the second point-of-interest marking control in the virtual scene; receiving, through the first detail area, a marking operation on the second point of interest after the first point-of-interest identifier is triggered on the virtual map; and receiving, through the second detail area, a marking operation on the second point of interest after the second point-of-interest identifier is triggered on the virtual map.

Operation 820: Display a marking effect of the second point of interest.

In some embodiments, the marking effect of the second point of interest includes at least one of the following.

First, a first guide identifier in the virtual scene.

The first guide identifier is configured for indicating direction information and distance information of the second point of interest relative to the primarily controlled virtual object in the virtual scene.

In some embodiments, the first guide identifier marks the position of the second point of interest and a real-time distance of the second point of interest relative to the primarily controlled virtual object in the virtual scene in a form of a float in real time. In the display process, a display position of the first guide identifier moves as the primarily controlled virtual object moves and a perspective range changes, and is always displayed at a real-time directional position of the second point of interest relative to the primarily controlled virtual object.

Second, a second guide identifier in a virtual compass.

The virtual compass is configured for representing, in the virtual scene, orientation information corresponding to a perspective of the primarily controlled virtual object, and the second guide identifier is configured for representing, in the virtual compass, direction information of the second point of interest relative to the perspective of the primarily controlled virtual object.

In some embodiments, the virtual compass is implemented as a coordinate scale bar, and is displayed in the virtual scene in a preset area of a terminal interface in an overlaying manner. The orientation information is indicated through orientation coordinates on the coordinate scale bar. The orientation coordinates in the virtual compass change as the perspective of the primarily controlled virtual object moves. The orientation coordinates that change in real time indicate a direction corresponding to a current perspective of the primarily controlled virtual object. For example, when the perspective range of the primarily controlled virtual object moves from left to right, the orientation coordinates in the virtual compass change from “east 20” to “south 10”. In some embodiments, the second guide identifier marks the orientation coordinates of the second point of interest relative to the current perspective of the primarily controlled virtual object in the virtual compass in the form of a float in real time.

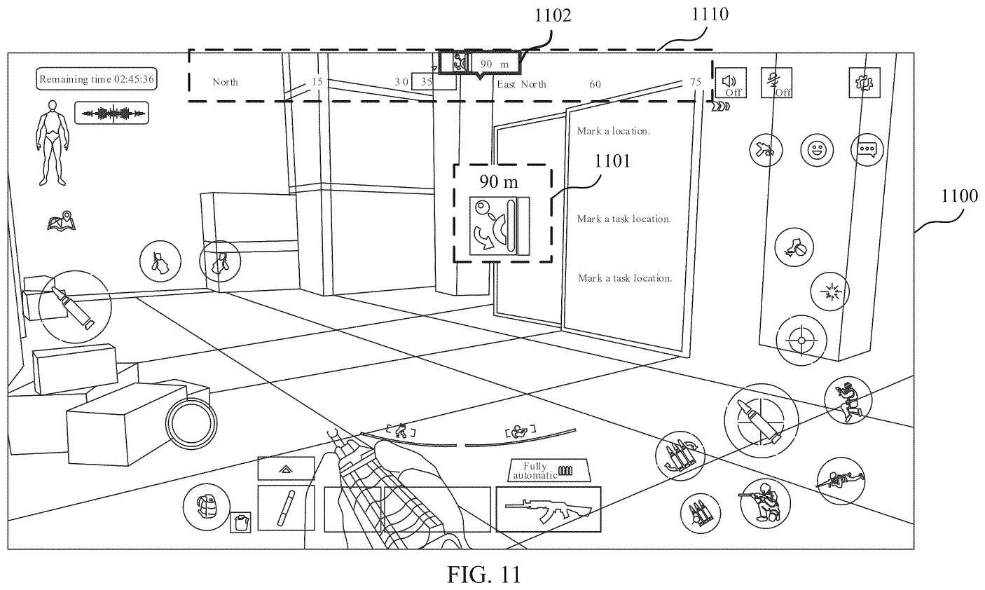

Exemplarily, FIG. 11 is a schematic diagram of a second point-of-interest marking effect according to an exemplary embodiment of this application. As shown in FIG. 11, a first guide identifier 1101 is displayed in a virtual scene 1100 in response to a marking operation on a second point of interest, and a second guide identifier 1102 is displayed in a virtual compass 1110.

Third, a marking element in the virtual map.

The marking element is configured for representing that the second point-of-interest identifier is marked.

In some embodiments, the marking element may be implemented as a highlight effect of the second point-of-interest identifier, an arrow identifier pointing to the second point-of-interest identifier, a rectangular frame centering on the second point-of-interest identifier, or the like.

Based on the above, according to the method provided in the embodiments of this application, the marking effect of the second point of interest is displayed by receiving the marking operation on the second point of interest, the marking process for the second point of interest is completed, and the primarily controlled virtual object is guided to head to the second point of interest, thereby improving efficiency of the human-computer interaction.

According to the method provided in the embodiments of this application, the second point-of-interest marking control is displayed in the virtual scene when the primarily controlled virtual object reaches the first area range when the second point of interest is not marked, the trigger operation on the second point-of-interest marking control is received. Alternatively, when the second point-of-interest identifier is displayed in the virtual map, the marking operation on the second point of interest is received in the detail area of the virtual map. Two marking manners are provided. Even if the user has no habit of viewing the virtual map, the second point of interest may be marked through the second point-of-interest marking control, thereby reducing cognitive and learning costs of the user, and improving efficiency of the human-computer interaction.

According to the method provided in the embodiments of this application, a plurality of marking effects of the second point of interest are provided, including the first guide identifier in the virtual scene, the second guide identifier in the virtual compass, and the marking element in the virtual map. The primarily controlled virtual object may be helped, by means of the first guide identifier, navigate to the second point of interest in a targeted manner through at least one of the direction information and the distance information. A position of the second point of interest may be relatively accurately learned by means of the second guide identifier through the orientation information. The position of the second point of interest may be determined from a global perspective of the virtual scene through the marking element. Through at least one of the foregoing marking effects, the primarily controlled virtual object may be diversified and intuitively guided to head to the second point of interest, thereby improving efficiency of human-computer interaction while enriching the picture display effect.

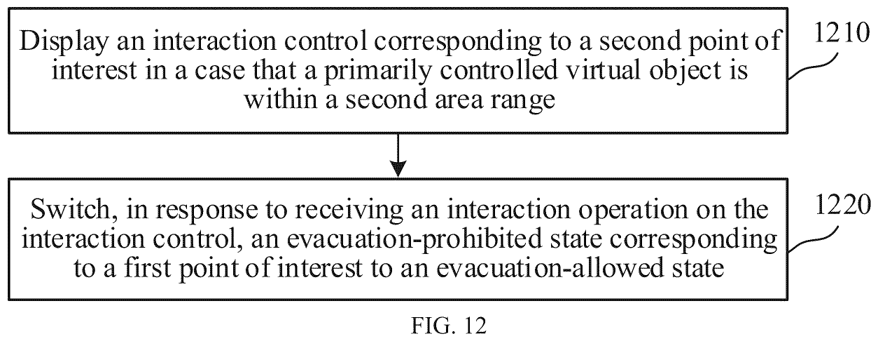

In some embodiments, the virtual scene-based identifier prompting method provided in the embodiments of this application further includes an interaction process for the second point of interest. FIG. 12 is a flowchart of a second point-of-interest interaction method according to an exemplary embodiment of this application. The method may be applied to a terminal, a server, or both a terminal and a server. In this embodiment of this application, a description is provided by using an example in which the method is applied to the terminal. As shown in FIG. 12, the method includes the following operations.

Operation 1210: Display an interaction control corresponding to a second point of interest when a primarily controlled virtual object is within a second area range.

The second area range is an area range corresponding to a position of the second point of interest in the virtual scene, and the interaction control is configured to adjust a functional status of the first point of interest.

In some embodiments, the interaction operation on the second point of interest is configured to switch the functional status of the first point of interest.

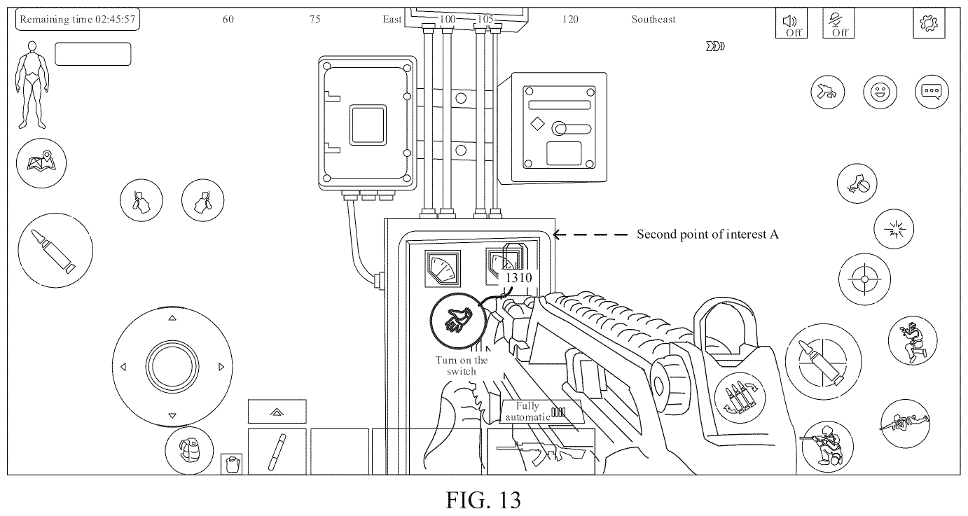

Exemplarily, FIG. 13 is a schematic diagram of an interaction control according to an exemplary embodiment of this application. As shown in FIG. 13, an interaction control 1310 corresponding to a second point of interest A is displayed when a primarily controlled virtual object is within a second area range.

Operation 1220: Switch, in response to receiving an interaction operation on the interaction control, an evacuation-prohibited state corresponding to the first point of interest to an evacuation-allowed state.

In some embodiments, the functional status of the first point of interest in a virtual battle is preset to the evacuation-prohibited state, and the evacuation-prohibited state corresponding to the first point of interest is switched to the evacuation-allowed state in response to receiving the interaction operation on the second point of interest.

In some embodiments, after the evacuation-prohibited state corresponding to the first point of interest is switched to the evacuation-allowed state, at least one of the following cases is included.

First, automatically marking the first point of interest, and displaying a marking effect corresponding to the first point of interest.

In some embodiments, the displaying a marking effect corresponding to the first point of interest may be implemented as: displaying a third guide identifier in the virtual scene, the third guide identifier being configured for representing direction information and distance information of the first point of interest relative to the primarily controlled virtual object in the virtual scene; and displaying a fourth guide identifier in the virtual compass, the fourth guide identifier being configured for representing direction information of a perspective of the first point of interest relative to the primarily controlled virtual object in the virtual compass.

Second, displaying the first point of interest with a perspective effect within a preset time range when a virtual obstacle occluding the first point of interest exists within a perspective range of the primarily controlled virtual object.

Exemplarily, when the first point of interest cannot be directly observed within the perspective range of the primarily controlled virtual object, the first point of interest is highlighted in the virtual scene with the perspective effect within 5 seconds. For example, display brightness of the first point of interest is greater than display brightness of another virtual building or virtual object in the virtual scene, and the transparency is less than that of the another virtual building or the virtual object.

Third, displaying a route guide identifier.

The route guide identifier is configured for indicating a shortest route for the primarily controlled virtual object to reach the first point of interest.

Exemplarily, a guide arrow that follows a real-time change of the perspective of the primarily controlled virtual object is displayed in the virtual scene, to indicate the shortest route for the primarily controlled virtual object to reach the first point of interest.

Fourth, displaying a plurality of route planning prompts.

The route planning prompts are configured for indicating a plurality of routes for the primarily controlled virtual object to reach the first point of interest, a duration required for the plurality of routes, and a roadblock condition.

Exemplarily, the plurality of route planning prompts are displayed in the virtual scene, and are respectively configured to indicate conditions of the plurality of routes, including the duration required for the plurality of routes, and a roadblock condition, for example, a quantity of virtual objects in the rival camps located on the routes, road blocks carried in the virtual scene, and a health point consumed by a route passing through a non-safe area. The non-safe area refers to an area in which the virtual object may be negatively affected such as blood deduction or deceleration. If the primarily controlled virtual object selects one of the route planning prompts, a route corresponding to the selected route planning prompt is used as a guide route for guiding movement of the primarily controlled virtual object, and another route planning prompt is undisplayed.

Based on the above, according to the method provided in the embodiments of this application, the interaction control corresponding to the second point of interest is displayed when the primarily controlled virtual object is within the second area range, the evacuation-prohibited state corresponding to the first point of interest is switched to the evacuation-allowed state in response to receiving the interaction operation, the second area range is used as a condition for adjusting the functional status corresponding to the first point of interest, and an objective of adjusting the functional status is implemented through the interaction control more quickly, so that control over the functional status of the first point of interest is implemented through the second point of interest, a state implementation is refined while game playability is improved, and game efficiency is improved.

According to the method provided in the embodiments of this application, a plurality of prompt schemes after the functional status of the first point of interest is switched are provided, including automatically marking the first point of interest and displaying the marking effect corresponding to the first point of interest, displaying the first point of interest with the perspective effect in the virtual scene within the preset time range when the virtual obstacle occluding the first point of interest exists within the perspective range of the primarily controlled virtual object, displaying the route guide identifier, and displaying the plurality of route planning prompts, which are configured for guiding the main control object to head to the first point of interest, thereby improving efficiency of the human-computer interaction.

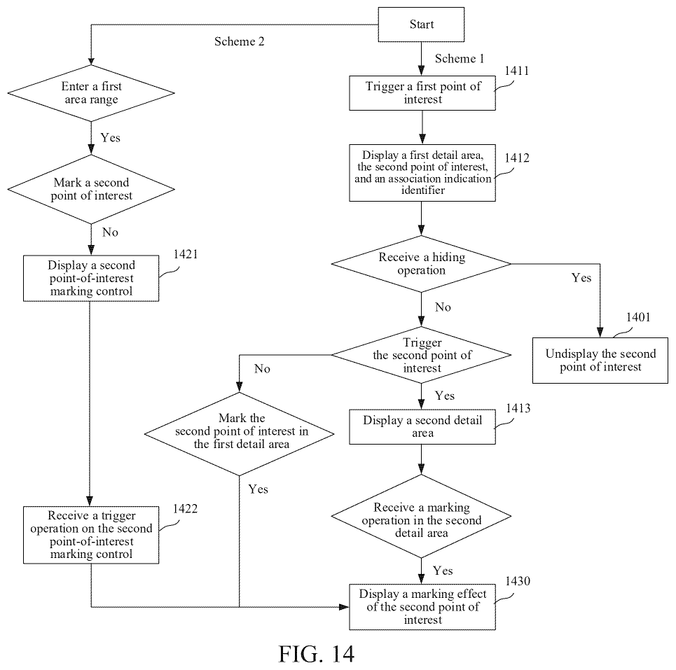

FIG. 14 is a flowchart of marking a second point of interest according to an exemplary embodiment of this application. The process may be performed by a terminal, a server, or both a terminal and a server. In this embodiment of this application, a description is provided by using an example in which the process is performed by the terminal. As shown in FIG. 14, in some embodiments, for the marking process of the second point of interest, if a virtual map is displayed in response to a map viewing operation, a scheme 1 is performed by the terminal, or if the virtual map is not displayed, a scheme 2 is performed by the terminal.

In some embodiments, the scheme 1 includes the following operations. Operation 1411: Trigger a first point of interest. Operation 1412: Display a first detail area, a second point of interest, and an association indication identifier. If a hiding operation is received, operation 1401 of removing the second detail area is performed. Otherwise, it is determined whether the second point of interest is triggered. If the second point of interest is triggered, operation 1413 of displaying a second detail area is performed. If the marking operation is received within the second detail area, operation 1430 of displaying a marking effect of the second point of interest is performed. If the second point of interest is not triggered, it is determined whether the second point of interest is marked in the first detail area; and if yes, operation 1430 of displaying a marking effect of the second point of interest is performed.

In some embodiments, the scheme 2 includes the following operations. It is determined whether the primarily controlled virtual object enters a first area range. If yes, it is determined whether the second point of interest is marked. In a case that the second point of interest is not marked, operation 1421 of displaying a second point-of-interest marking control is performed. Operation 1422: Receive a trigger operation on the second point-of-interest marking control. Operation 1430: Display a marking effect of the second point of interest.

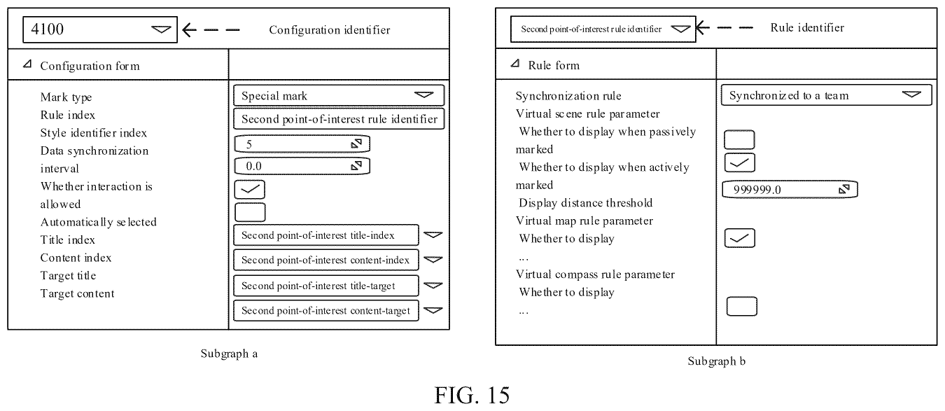

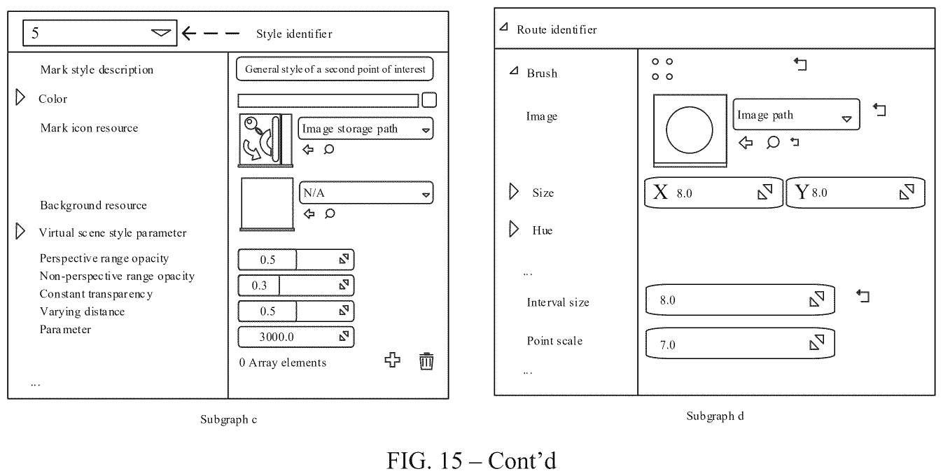

In some embodiments, an element configuration system is deployed on the terminal or the server that performs the virtual scene-based identifier prompting method. Display elements such as the marking effect related to a marking function and the association indication identifier in the embodiments of this application may all be configured through the element configuration system. Exemplarily, FIG. 15 is a schematic diagram showing configuration of a display element according to an exemplary embodiment of this application. As shown in FIG. 15, a subgraph a shows an index configuration of a single marking effect, and a configuration form of a display element may be indexed through a configuration identifier. A subgraph b shows a rule configuration of the single marking effect, and a rule form of the display element may be indexed through a rule identifier. A subgraph c shows a style configuration of the single marking effect, and the style configuration of the display element may be indexed through a style identifier. A subgraph d shows a drawing configuration of the association indication identifier, which is configured for drawing a route identifier in the virtual map, for example, the association indication identifier and the like. Several transition points may be interpolated based on a configured interval size through positions of a starting point and an end point of the route identifier and drawn on a terminal interface to form the route identifier. In some embodiments, displaying and removing of the second point-of-interest marking control on the interface are configured based on an interaction situation or a position situation between the primarily controlled virtual object and the first point of interest. In some embodiments, the second point-of-interest marking control is displayed when the primarily controlled virtual object does not implement interaction with the first point of interest, and the second point-of-interest marking control is undisplayed when the primarily controlled virtual object implements interaction with the first point of interest. The second point-of-interest marking control is displayed when the primarily controlled virtual object enters the first area range, and the second point-of-interest marking control is undisplayed when the primarily controlled virtual object leaves the first area range.

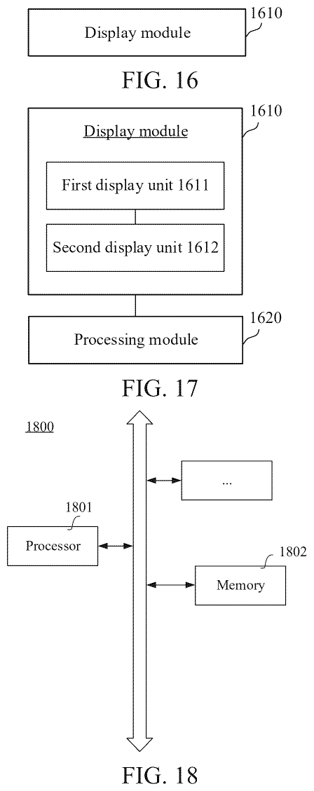

FIG. 16 is a structural block diagram of a virtual scene-based identifier prompting apparatus according to an exemplary embodiment of this application. As shown in FIG. 16, the apparatus includes the following part:
a display module 1610, configured to display a virtual scene, the virtual scene including a primarily controlled virtual object.

The display module 1610 is further configured to display a virtual map in response to a map viewing operation, the virtual map being configured to represent a scene distribution of the virtual scene, the virtual map including at least one first point-of-interest identifier, the first point-of-interest identifier being configured for representing a position of a first point of interest in the virtual scene, and the first point of interest being configured for implementing a function that the virtual object evacuates the virtual scene; and

The display module 1610 is further configured to display, in response to receiving a trigger operation on the first point-of-interest identifier, a second point-of-interest identifier and an association indication identifier, the second point-of-interest identifier being configured for representing a position of a second point of interest in the virtual scene, a correspondence existing between the first point of interest and the second point of interest, the association indication identifier being configured for indicating the correspondence, and the second point of interest being configured for controlling a functional status of the first point of interest.

In some embodiments, the display module 1610 is further configured to display, in response to receiving the trigger operation on the first point-of-interest identifier, the second point-of-interest identifier and the association indication identifier on the virtual map, and display a first detail area corresponding to the first point of interest, the first detail area being configured to allow displaying of first information of the first point of interest.

In some embodiments, the display module 1610 is further configured to display a marking effect of the second point of interest when a marking operation on the second point of interest is received in the first detail area.

In some embodiments, the display module 1610 is further configured to:
display, in response to receiving a trigger operation on the second point-of-interest identifier, a second detail area corresponding to the second point of interest, the second detail area being configured to allow displaying of second information of the second point of interest; and
display a marking effect of the second point of interest in response to receiving a marking operation on the second point of interest in the second detail area.

In some embodiments, the display module 1610 is further configured to:
display a second point-of-interest marking control in the virtual scene when the primarily controlled virtual object is located within a first area range and the second point of interest is not marked, the first area range being an area range corresponding to the position of the first point of interest in the virtual scene; and
display a marking effect of the second point of interest in response to receiving a trigger operation on the second point-of-interest marking control.

In some embodiments, the marking effect includes at least one of the following:
a first guide identifier in the virtual scene, the first guide identifier being configured for indicating direction information and distance information of the second point of interest relative to the primarily controlled virtual object in the virtual scene; and
a second guide identifier in a virtual compass, the virtual compass being configured for indicating, in the virtual scene, orientation information corresponding to a perspective of the primarily controlled virtual object, and the second guide identifier being configured for indicating, in the virtual compass, the direction information of the second point of interest relative to the perspective of the primarily controlled virtual object; and
a marking element on the virtual map, the marking element being configured for indicating that the second point-of-interest identifier is marked.

FIG. 17 is a structural block diagram of modules of a virtual scene-based identifier prompting apparatus according to an exemplary embodiment of this application. As shown in FIG. 17, in some embodiments, the display module 1610 includes:
a first display unit 1611, configured to display, in response to the trigger operation on the first point-of-interest identifier when the virtual object does not exist within a first area range of a historical time range, the second point-of-interest identifier and the association indication identifier on the virtual map with a first display effect, the first area range being an area range corresponding to the position of the first point of interest in the virtual scene; and
a second display unit 1612, configured to display, in response to the trigger operation on the first point-of-interest identifier when the virtual object exists within the first area range of the historical time range, the second point-of-interest identifier and the association indication identifier on the virtual map with a second display effect.

In some embodiments, the second display unit 1612 is configured to:
display the association indication identifier on the virtual map when the second point of interest is in an enabled state, and display the second point-of-interest identifier with a third display effect, the enabled state being configured for controlling the functional status to be implemented as an evacuation-allowed state indicating that the primarily controlled virtual object evacuates through the first point of interest; or
display the association indication identifier on the virtual map when the second point of interest is in a disabled state, and display the second point-of-interest identifier with a fourth display effect, the disabled state being configured for controlling the functional status to be implemented as an evacuation-prohibited state indicating that the primarily controlled virtual object is unable to evacuate through the first point of interest.

In some embodiments, the display module 1610 is configured to:
display, in response to receiving the trigger operation on the first point-of-interest identifier, a single second point-of-interest identifier and a single association indication identifier on the virtual map; or
display, in response to receiving the trigger operation on the first point-of-interest identifier, a plurality of second point-of-interest identifiers and a plurality of association indication identifiers on the virtual map; or
display, in response to receiving the trigger operation on the first point-of-interest identifier, a single second point-of-interest identifier and a plurality of association indication identifiers on the virtual map.

In some embodiments, the display module 1610 is further configured to undisplay the second point-of-interest identifier and the association indication identifier in response to a hiding operation.

In some embodiments, the display module 1610 is further configured to: undisplay, in response to receiving an area trigger operation for a hidden area as the hiding operation, the second point-of-interest identifier and the association indication identifier, the hidden area being an area other than a point-of-interest identifier on the virtual map; or undisplay, in response to receiving an identifier trigger operation for a third point-of-interest identifier as the hiding operation, the second point-of-interest identifier and the association indication identifier, a third point of interest corresponding to the third point-of-interest identifier being another point of interest that does not have the correspondence with the first point of interest.

In some embodiments, the apparatus further includes a processing module 1620.

The display module 1610 is further configured to display an interaction control corresponding to the second point of interest when the primarily controlled virtual object is within the second area range, the second area range being an area range corresponding to the position of the second point of interest in the virtual scene.

The processing module 1620 is configured to switch, in response to receiving an interaction operation on the interaction control, the evacuation-prohibited state corresponding to the first point of interest to the evacuation-allowed state.

In some embodiments, the display module 1610 is further configured to:
automatically mark the first point of interest, and display a marking effect corresponding to the first point of interest; or
display the first point of interest with a perspective effect within a preset time range when a virtual obstacle occluding the first point of interest exists within a perspective range of the primarily controlled virtual object; or
display a route guide identifier, the route guide identifier being configured for indicating a shortest route for the primarily controlled virtual object to reach the first point of interest; or
display a plurality of route planning prompts, the route planning prompts being configured for indicating a plurality of routes for the primarily controlled virtual object to reach the first point of interest, a duration required for the plurality of routes, and a roadblock condition.

In some embodiments, the marking effect corresponding to the first point of interest includes:
a third guide identifier in the virtual scene, the third guide identifier being configured for indicating, in the virtual, scene direction information and distance information of the first point of interest relative to the primarily controlled virtual object; and
a fourth guide identifier in the virtual compass, the fourth guide identifier being configured for indicating, in the virtual compass, the direction information of the first point of interest relative to the perspective of the primarily controlled virtual object.

In some embodiments, the first point of interest is configured for implementing a function that the virtual object in a virtual battle carries a virtual resource to evacuate the virtual scene, the virtual resource including a resource obtained by the virtual object from the virtual battle.

Based on the above, in the apparatus provided in the embodiments of this application, the virtual map configured to represent the scene distribution of the virtual scene is displayed through the map viewing operation, and the second point-of-interest identifier and the association indication identifier are displayed based on the trigger operation on the first point-of-interest identifier on the virtual map. A correspondence exists between the first point of interest and the second point of interest, and the second point of interest may control the functional status of the first point of interest. The process of triggering the first point-of-interest identifier to display the second point-of-interest identifier and the association indication identifier may avoid a problem of clutter on interface display because excessive point-of-interest identifiers are displayed on the virtual map. The second point-of-interest identifier is displayed as an attached identifier behind the first point-of-interest identifier, to fully utilize the correspondence between the first point-of-interest identifier and the second point-of-interest identifier. The correspondence may further be embodied through the association indication identifier more clearly and intuitively, thereby simplifying the point-of-interest identifiers on the virtual map, and avoiding a problem of data interference caused by excessive identifiers display on the user. Readability of the virtual map is improved, and efficiency of human-computer interaction is helped improve.

For the virtual scene-based identifier prompting apparatus provided in the foregoing embodiments, only division of the functional modules is described by using an example. In practical application, the functions are completed by different functional modules as required. In other words, an internal structure of the device is divided into different functional modules to complete all or a part of the functions described above. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

FIG. 18 is a structural block diagram of a terminal 1800 according to an exemplary embodiment of this application. The terminal 1800 may be a smartphone, a tablet computer, an MP3 player, an MP4 player, a notebook computer, or a desktop computer. The terminal 1800 may also be referred to as another name such as user device, a portable terminal, a laptop terminal, or a desktop terminal.

Generally, the terminal 1800 includes a processor 1801 and a memory 1802.

The processor 1801 may include one or more processing cores, for example, a 4-core processor or an 8-core processor. The processor 1801 may be implemented in at least one hardware form of a digital signal processor (DSP), a field-programmable gate array (FPGA), and a programmable logic array (PLA). The processor 1801 may alternatively include a main processor and a coprocessor. The main processor is a processor configured to process data in an awaken state, which is also referred to as a central processing unit (CPU). The coprocessor is a low-power processor configured to process data in a standby state. In some embodiments, the processor 1801 may be integrated with a graphics processing unit (GPU). The GPU is configured to render and draw content that needs to be displayed on a display screen. In some embodiments, the processor 1801 may further include an AI processor. The AI processor is configured to perform computing operations related to machine learning.

The memory 1802 may include one or more computer-readable storage media. The computer-readable storage medium may be non-transient. The memory 1802 may further include a high-speed random access memory (RAM) and a nonvolatile memory, for example, one or more disk storage devices or flash storage devices. In some embodiments, the non-transitory computer-readable storage medium in the memory 1802 is configured to store at least one instruction, the at least one instruction being configured to be executed by the processor 1801 to implement the virtual scene-based identifier prompting method provided in the method embodiments of this application.

In some embodiments, the terminal 1800 further includes another assembly. A person skilled in the art may understand that the structure shown in FIG. 18 does not constitute a limitation on the terminal 1800. The terminal may include more or fewer assemblies than those shown in the figure, or some merged assemblies, or different assembly arrangements.

An embodiment of this application further provides a computer device. The computer device may be implemented as the terminal or the server shown in FIG. 2. The computer device includes a processor and a memory, the memory storing at least one instruction, at least one program, a code set, or an instruction set, the at least one instruction, the at least one program, the code set, or the instruction set being loaded and executed by a processor to implement the virtual scene-based identifier prompting method provided in the foregoing method embodiments.

An embodiment of this application further provides a non-transitory computer-readable storage medium, having at least one instruction, at least one program, a code set, or an instruction set stored therein, the at least one instruction, the at least one program, the code set, or the instruction set being loaded and executed by a processor to implement the virtual scene-based identifier prompting method provided in the foregoing method embodiments.

An embodiment of this application further provides a computer program product or a computer program, the computer program product or the computer program including a computer instruction, the computer instruction being stored in a non-transitory computer-readable storage medium. A processor of a computer device reads the computer instruction from the computer-readable storage medium, and the processor executes the computer instruction, so that the computer device performs the virtual scene-based identifier prompting method provided in the foregoing method embodiments.

In some embodiments, the computer-readable storage medium may include a read only memory (ROM), a RAM, a solid state drive (SSD), an optical disc, and the like. The RAM may include a resistance random access memory (ReRAM) and a dynamic random access memory (DRAM). The sequence numbers of the foregoing embodiments of this application are merely for description, and do not represent the preference of the embodiments.

A person of ordinary skill in the art may understand that all or some of the operations implementing the above embodiments may be implemented by hardware, or may be implemented by instructing related hardware through a program. The program may be stored in a non-transitory computer-readable storage medium. The storage medium may be a ROM, a disk, an optical disc, or the like.

The above descriptions are merely exemplary embodiments of this application, and are not intended to limit this application. Any modification, equivalent replacement, or improvement made within the spirit and principle of this application falls within the protection scope of this application.

What is claimed is:

1. A virtual scene-based identifier prompting method performed by a computer device, the method comprising:
displaying a virtual scene, the virtual scene comprising a virtual object controlled by a user of the computer device;
in response to a map viewing operation by the user of the computer device, displaying a virtual map representing a scene distribution of the virtual scene, the virtual map comprising at least one first point-of-interest identifier representing a position of a first point of interest in the virtual scene; and
in response to a trigger operation on the first point-of-interest identifier by the user of the computer device, displaying, on the virtual map, a second point-of-interest identifier representing a position of a second point of interest in the virtual scene and an association indication identifier indicating a correspondence between the first point of interest and the second point of interest, wherein the second point of interest is configured for controlling a functional status of the first point of interest.

2. The method according to claim 1, wherein the displaying the second point-of-interest identifier and the association indication identifier comprises:
displaying a first detail area corresponding to the first point of interest, the first detail area including first information of the first point of interest.

3. The method according to claim 2, wherein after the displaying the first detail area corresponding to the first point of interest, the method further comprises:
displaying a marking effect of the second point of interest when a marking operation on the second point of interest is received in the first detail area.

4. The method according to claim 1, wherein after the displaying the second point-of-interest identifier and the association indication identifier, the method further comprises:
in response to a trigger operation on the second point-of-interest identifier by the user of the computer device, displaying a second detail area corresponding to the second point of interest, the second detail area including second information of the second point of interest; and
displaying a marking effect of the second point of interest in response to receiving a marking operation on the second point of interest in the second detail area.

5. The method according to claim 1, further comprising:
displaying a second point-of-interest marking control in the virtual scene when the virtual object is located within a first area range corresponding to the position of the first point of interest in the virtual scene and the second point of interest is not marked; and
displaying a marking effect of the second point of interest in response to a trigger operation on the second point-of-interest marking control.

6. The method according to claim 1, wherein the displaying the second point-of-interest identifier and the association indication identifier comprises:
when the virtual object does not exist within a second area range of a historical time range, displaying the second point-of-interest identifier and the association indication identifier on the virtual map with a first display effect, the second area range being an area range corresponding to the position of the second point of interest in the virtual scene; and
when the virtual object exists within the second area range of the historical time range, displaying the second point-of-interest identifier and the association indication identifier on the virtual map with a second display effect.

7. The method according to claim 1, wherein the displaying the second point-of-interest identifier and the association indication identifier comprises:
in response to the trigger operation on the first point-of-interest identifier, displaying a single second point-of-interest identifier and a single association indication identifier on the virtual map; or
in response to the trigger operation on the first point-of-interest identifier, displaying a plurality of second point-of-interest identifiers and a plurality of association indication identifiers on the virtual map; or
in response to the trigger operation on the first point-of-interest identifier, displaying a single second point-of-interest identifier and a plurality of association indication identifiers on the virtual map.

8. The method according to claim 1, wherein after the displaying the second point-of-interest identifier and the association indication identifier, the method further comprises:
removing the second point-of-interest identifier and the association indication identifier the virtual map in response to a hiding operation.

9. The method according to claim 1, further comprising:
displaying an interaction control corresponding to the second point of interest when the virtual object is within the second area range; and
in response to an interaction operation on the interaction control, switching the first point of interest from an evacuation-prohibited state to an evacuation-allowed state.

10. The method according to claim 1, wherein the first point of interest is configured for implementing a function that the virtual object carries a virtual resource to evacuate the virtual scene in a virtual battle, the virtual resource comprising a resource obtained by the virtual object from the virtual battle.

11. A computer device, comprising a processor and a memory, the memory having at least one computer program stored therein, the at least one computer program being loaded and executed by the processor and causing the computer device to implement a virtual scene-based identifier prompting method including:
displaying a virtual scene, the virtual scene comprising a virtual object controlled by a user of the computer device;
in response to a map viewing operation by the user of the computer device, displaying a virtual map representing a scene distribution of the virtual scene, the virtual map comprising at least one first point-of-interest identifier representing a position of a first point of interest in the virtual scene; and
in response to a trigger operation on the first point-of-interest identifier by the user of the computer device, displaying, on the virtual map, a second point-of-interest identifier representing a position of a second point of interest in the virtual scene and an association indication identifier indicating a correspondence between the first point of interest and the second point of interest, wherein the second point of interest is configured for controlling a functional status of the first point of interest.

12. The computer device according to claim 11, wherein the displaying the second point-of-interest identifier and the association indication identifier comprises:
displaying a first detail area corresponding to the first point of interest, the first detail area including first information of the first point of interest.

13. The computer device according to claim 12, wherein after the displaying the first detail area corresponding to the first point of interest, the method further comprises:
displaying a marking effect of the second point of interest when a marking operation on the second point of interest is received in the first detail area.

14. The computer device according to claim 11, wherein after the displaying the second point-of-interest identifier and the association indication identifier, the method further comprises:
in response to a trigger operation on the second point-of-interest identifier by the user of the computer device, displaying a second detail area corresponding to the second point of interest, the second detail area including second information of the second point of interest; and
displaying a marking effect of the second point of interest in response to receiving a marking operation on the second point of interest in the second detail area.

15. The computer device according to claim 11, wherein the method further comprises:
displaying a second point-of-interest marking control in the virtual scene when the virtual object is located within a first area range corresponding to the position of the first point of interest in the virtual scene and the second point of interest is not marked; and
displaying a marking effect of the second point of interest in response to a trigger operation on the second point-of-interest marking control.

16. The computer device according to claim 11, wherein the displaying the second point-of-interest identifier and the association indication identifier comprises:
when the virtual object does not exist within a second area range of a historical time range, displaying the second point-of-interest identifier and the association indication identifier on the virtual map with a first display effect, the second area range being an area range corresponding to the position of the second point of interest in the virtual scene; and
when the virtual object exists within the second area range of the historical time range, displaying the second point-of-interest identifier and the association indication identifier on the virtual map with a second display effect.

17. The computer device according to claim 11, wherein the displaying the second point-of-interest identifier and the association indication identifier comprises:
in response to the trigger operation on the first point-of-interest identifier, displaying a single second point-of-interest identifier and a single association indication identifier on the virtual map; or
in response to the trigger operation on the first point-of-interest identifier, displaying a plurality of second point-of-interest identifiers and a plurality of association indication identifiers on the virtual map; or
in response to the trigger operation on the first point-of-interest identifier, displaying a single second point-of-interest identifier and a plurality of association indication identifiers on the virtual map.

18. The computer device according to claim 11, wherein the method further comprises:
displaying an interaction control corresponding to the second point of interest when the virtual object is within the second area range; and
in response to an interaction operation on the interaction control, switching the first point of interest from an evacuation-prohibited state to an evacuation-allowed state.

19. The computer device according to claim 11, wherein the first point of interest is configured for implementing a function that the virtual object carries a virtual resource to evacuate the virtual scene in a virtual battle, the virtual resource comprising a resource obtained by the virtual object from the virtual battle.

20. A non-transitory computer-readable storage medium, having at least one computer program stored therein, the at least one computer program being loaded and executed by a processor of a computer device and causing the computer device to implement a virtual scene-based identifier prompting method including:
displaying a virtual scene, the virtual scene comprising a virtual object controlled by a user of the computer device;
in response to a map viewing operation by the user of the computer device, displaying a virtual map representing a scene distribution of the virtual scene, the virtual map comprising at least one first point-of-interest identifier representing a position of a first point of interest in the virtual scene; and
in response to a trigger operation on the first point-of-interest identifier by the user of the computer device, displaying, on the virtual map, a second point-of-interest identifier representing a position of a second point of interest in the virtual scene and an association indication identifier indicating a correspondence between the first point of interest and the second point of interest, wherein the second point of interest is configured for controlling a functional status of the first point of interest.
